(19) United States
(12) Patent Application Publication
(10) Pub. No.: US 2026/0281705 A1
(43) Pub. Date: Sep. 17, 2026

(54) INFORMATION SENDING METHOD, INFORMATION RECEIVING METHODS, APPARATUS AND COMMUNICATION DEVICE

(71) Applicant: VIVO MOBILE COMMUNICATION CO., LTD., Dongguan (CN)

(72) Inventors: Shengli DING, Dongguan (CN); Yannan YUAN, Dongguan (CN)

(21) Appl. No.: 19/168,529

(22) PCT Filed: Apr. 3, 2024
(86) PCT No.: PCT/CN2024/085708

§ 371 Date: Sep. 24, 2025

(30) Foreign Application Priority Data
Apr. 3, 2023 (CN) 202310346779.1

(51) Int. Cl. H04W 8/24; H04W 24/08; H04W 24/10; H04W 72/21

(52) U.S. Cl. CPC H04W 8/24; H04W 24/08; H04W 24/10; H04W 72/21

(57) ABSTRACT

An information sending method includes: a first communication device sending device capability information of the first communication device to a second communication device, the device capability information of the first communication device including at least one piece of the following sensing capability information: indication information used for indicating whether to support sensing, sensing mobility management capability information, sensing reporting capability information, sensing information processing capability information, sensing signal support capability information, adaptive capability information of a sensing link, and sensing auxiliary support capability information.

### CROSS-REFERENCE TO RELATED APPLICATIONS

This is the national stage application of International Patent Application No. PCT/CN2024/085708, filed on Apr. 3, 2024, which claims the benefit of and priority to Chinese Patent Application No. 202310346779.1, filed on Apr. 3, 2023. The foregoing applications are incorporated by reference in their entireties herein.

### TECHNICAL FIELD

This application relates to the field of communication technologies and, more specifically, relates to an information sending method and apparatus, an information receiving method and apparatus, and a communication device.

### BACKGROUND

In a related technology, the exchange of device capabilities is limited to communication-related functions. Because only communication-related capabilities are exchanged, the types of capabilities shared between devices lacks diversity.

### BRIEF SUMMARY

Embodiments of this application provide an information sending method and apparatus, an information receiving method and apparatus, and a communication device, so as to resolve a problem that a type of a capability exchanged between devices is undiversified.

According to a first aspect, an information sending method is provided and is performed by a first communication device, and the method includes: sending device capability information of the first communication device to a second communication device, where the device capability information of the first communication device includes at least one piece of the following sensing capability information: indication information used to indicate whether sensing is supported; sensing mobility management capability information; sensing reporting capability information; sensing information processing capability information; sensing signal support capability information; sensing link adaptation capability information; and sensing assistance support capability information.

According to a second aspect, an information receiving method is provided and is performed by a second communication device, and the method includes: receiving device capability information of a first communication device that is sent by the first communication device, where the device capability information of the first communication device includes at least one piece of the following sensing capability information: indication information used to indicate whether sensing is supported; sensing mobility management capability information; sensing reporting capability information; sensing information processing capability information; sensing signal support capability information; sensing link adaptation capability information; and sensing assistance support capability information.

According to a third aspect, an information receiving method is provided and is performed by a third communication device, and the method includes: receiving device capability information of a first communication device that is sent by a second communication device, where the device capability information of the first communication device includes at least one piece of the following sensing capability information: indication information used to indicate whether sensing is supported; sensing mobility management capability information; sensing reporting capability information; sensing information processing capability information; sensing signal support capability information; sensing link adaptation capability information; and sensing assistance support capability information.

According to a fourth aspect, an information sending apparatus is provided, where a first communication device includes the information sending apparatus, and the information sending apparatus includes a sending module, configured to send device capability information of the first communication device to a second communication device, where the device capability information of the first communication device includes at least one piece of the following sensing capability information: indication information used to indicate whether sensing is supported; sensing mobility management capability information; sensing reporting capability information; sensing information processing capability information; sensing signal support capability information; sensing link adaptation capability information; and sensing assistance support capability information.

According to a fifth aspect, an information receiving apparatus is provided, where a second communication device includes the information receiving apparatus, and the information receiving apparatus includes a first receiving module, configured to receive device capability information of a first communication device that is sent by the first communication device, where the device capability information of the first communication device includes at least one piece of the following sensing capability information: indication information used to indicate whether sensing is supported; sensing mobility management capability information; sensing reporting capability information; sensing information processing capability information; sensing signal support capability information; sensing link adaptation capability information; and sensing assistance support capability information.

According to a sixth aspect, an information receiving apparatus is provided, where a third communication device includes the information receiving apparatus, and the information receiving apparatus includes a receiving module, configured to receive device capability information of a first communication device that is sent by a second communication device, where the device capability information of the first communication device includes at least one piece of the following sensing capability information: indication information used to indicate whether sensing is supported; sensing mobility management capability information; sensing reporting capability information; sensing information processing capability information; sensing signal support capability information; sensing link adaptation capability information; and sensing assistance support capability information.

According to a seventh aspect, a communication device is provided, where the communication device includes a processor and a memory, the memory stores a program or instructions capable of running on the processor, and the program or the instructions are executed by the processor to implement the steps of the method according to the first aspect or the second aspect or the third aspect.

According to an eighth aspect, a communication device is provided, including a processor and a communication interface, where the communication interface is configured to send device capability information of a first communication device to a second communication device, where the device capability information of the first communication device includes at least one piece of the following sensing capability information: indication information used to indicate whether sensing is supported; sensing mobility management capability information; sensing reporting capability information; sensing information processing capability information; sensing signal support capability information; sensing link adaptation capability information; and sensing assistance support capability information; or
the communication interface is configured to receive device capability information of a first communication device that is sent by the first communication device, where the device capability information of the first communication device includes at least one piece of the following sensing capability information: indication information used to indicate whether sensing is supported; sensing mobility management capability information; sensing reporting capability information; sensing information processing capability information; sensing signal support capability information; sensing link adaptation capability information; and sensing assistance support capability information; or
the communication interface is configured to receive device capability information of a first communication device that is sent by a second communication device, where the device capability information of the first communication device includes at least one piece of the following sensing capability information: indication information used to indicate whether sensing is supported; sensing mobility management capability information; sensing reporting capability information; sensing information processing capability information; sensing signal support capability information; sensing link adaptation capability information; and sensing assistance support capability information.

According to a ninth aspect, an information transceiving system is provided, including a first communication device, a second communication device, and a third communication device, where the first communication device may be configured to perform the steps of the method according to the first aspect, the second communication device may be configured to perform the steps of the method according to the second aspect, and the third communication device may be configured to perform the steps of the method according to the third aspect.

According to a tenth aspect, a readable storage medium is provided, where the readable storage medium stores a program or instructions, and the program or the instructions are executed by a processor to implement the steps of the method according to the first aspect, or to implement the steps of the method according to the second aspect, or to implement the steps of the method according to the third aspect.

According to an eleventh aspect, a chip is provided, where the chip includes a processor and a communication interface, the communication interface is coupled to the processor, and the processor is configured to run a program or instructions to implement the steps of the method according to the first aspect, or to implement the steps of the method according to the second aspect, or to implement the steps of the method according to the third aspect.

According to a twelfth aspect, a computer program/program product is provided, where the computer program/program product is stored in a storage medium, and the computer program/program product is executed by at least one processor to implement the steps of the method according to the first aspect, or to implement the steps of the method according to the second aspect, or to implement the steps of the method according to the third aspect.

In the embodiments of this application, the first communication device sends device capability information of the first communication device to the second communication device, where the device capability information of the first communication device includes at least one piece of the following sensing capability information: indication information used to indicate whether sensing is supported; sensing mobility management capability information; sensing reporting capability information; sensing information processing capability information; sensing signal support capability information; sensing link adaptation capability information; and sensing assistance support capability information. In this way, the first communication device reports sensing-related capability information to the second communication device, so that exchange of the device capability information extends from exchange of communication capability information only in a related technology to exchange of the device capability information including sensing capability information, thereby avoiding an undiversified type of a capability exchanged between devices, and supporting integrated sensing and communication.

### BRIEF DESCRIPTION OF DRAWINGS

FIG. 1 is a block diagram of a wireless communication system to which an embodiment of this application is applicable;

FIG. 2 is a schematic diagram of a sensing scenario to which an embodiment of this application is applicable;

FIG. 3 is a schematic diagram of capability exchange in a related technology;

FIG. 4 is a schematic diagram of calculating an SNR for a one-dimensional map in a related technology;

FIG. 5 is a schematic diagram of calculating an SNR for a two-dimensional map in a related technology;

FIG. 6 is a flowchart of an information sending method according to an embodiment of this application;

FIG. 7 is a flowchart 1 of an information receiving method according to an embodiment of this application;

FIG. 8 is a flowchart 2 of an information receiving method according to an embodiment of this application;

FIG. 9 is a schematic diagram 1 of a process of device capability exchange according to an embodiment of this application;

FIG. 10 is a schematic diagram 2 of a process of device capability exchange according to an embodiment of this application;

FIG. 11 is a schematic diagram of a structure of an information receiving apparatus according to an embodiment of this application;

FIG. 12 is a schematic diagram 1 of a structure of an information sending apparatus according to an embodiment of this application;

FIG. 13 is a schematic diagram 2 of a structure of an information sending apparatus according to an embodiment of this application;

FIG. 14 is a schematic diagram of a structure of a communication device according to an embodiment of this application;

FIG. 15 is a schematic diagram of a structure of a terminal according to an embodiment of this application;

FIG. 16 is a schematic diagram 1 of a structure of a network side device according to an embodiment of this application; and

FIG. 17 is a schematic diagram 2 of a structure of a network side device according to an embodiment of this application.

### DETAILED DESCRIPTION OF EMBODIMENTS

The following describes technical solutions in embodiments of this application with reference to accompanying drawings in the embodiments of this application. Understandably, the described embodiments are merely some rather than all of the embodiments of this application. All other embodiments obtained by a person of ordinary skill in the art based on embodiments of this application shall fall within the protection scope of this application.

The terms “first”, “second”, and the like in this application are used to distinguish between similar objects instead of describing a specified order or sequence. It should be understood that, terms used in this way are interchangeable under appropriate circumstances, so that embodiments of this application can be implemented in a sequence other than that illustrated or described herein. Moreover, the terms “first” and “second” typically distinguish between objects of one category rather than limiting a quantity of objects. For example, there may be one or more first objects. In addition, “or” in this application represents at least one of connected objects. For example, “A or B” includes three solutions, that is, solution 1: including A and not including B; solution 2: including B and not including A; and solution 3: including both A and B. The character “/” generally represents an “or” relationship between associated objects.

The term “indication” in this application may be either a direct indication (or an explicit indication) or an indirect indication (or an implicit indication). The direct indication may be understood as: A sender explicitly notifies, in a sent indication, a receiver of specific information, an operation that needs to be performed, a requested result, or other content. The indirect indication may be understood as: The receiver determines corresponding information based on the indication sent by the sender, or performs determining based on the indication sent by the sender, and determines, based on a determining result, the operation that needs to be performed, the requested result, or the like.

It should be noted that, a technology described in embodiments of this application is not limited to a long term evolution (LTE)/LTE-advanced (LTE-A) system, and may be further applied to other wireless communication systems, such as a code division multiple access (CDMA) system, a time division multiple access (TDMA) system, a frequency division multiple access (FDMA) system, an orthogonal frequency division multiple access (OFDMA) system, a single-carrier frequency-division multiple access (SC-FDMA) system, or another system. The terms “system” and “network” are often used interchangeably in the embodiments of this application. The technology described may be used for the systems and radio technologies described above, as well as other systems and radio technologies. The following describes a new radio (NR) system for illustrative purposes, and NR terms are used in most of the following descriptions. However, these technologies are also applicable to systems such as a 6th generation (6G) communication system other than the NR system.

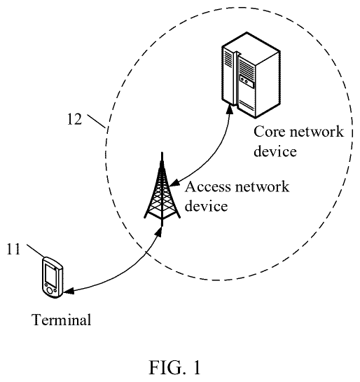

FIG. 1 is a block diagram of a wireless communication system to which an embodiment of this application is applicable. The wireless communication system includes a terminal 11 and a network side device 12. The terminal 11 may be a mobile phone, a tablet personal computer, a laptop computer, a notebook computer, a personal digital assistant (PDA), a palmtop computer, a netbook, an ultra-mobile personal computer (UMPC), a mobile internet device (Mobile Internet Device, MID), an augmented reality (AR)/virtual reality (VR) device, a robot, a wearable device (Wearable Device), a flight vehicle, vehicle user equipment (VUE), ship-mounted equipment, pedestrian user equipment (PUE), a smart home (a home device with a wireless communication function, for example, a refrigerator, a television, a laundry machine, or a furniture), a gaming console, a personal computer (PC), a teller machine, a self-service machine, or another terminal side device. The wearable device includes: a smart watch, a smart band, a smart headset, smart glasses, smart jewelry (a smart bracelet, a smart wristlet, a smart ring, a smart necklace, a smart anklet, a smart leglet, and the like), a smart wristband, smart clothing, and the like. The vehicle user equipment may also be referred to as a vehicle-mounted terminal, a vehicle-mounted controller, a vehicle-mounted module, a vehicle-mounted component, a vehicle-mounted chip, a vehicle-mounted unit, or the like. It should be noted that a specific type of the terminal 11 is not limited in the embodiments of this application. The network side device 12 may include an access network device or a core network device. The access network device may also be referred to as a radio access network (RAN) device, a radio access network function, or a radio access network unit. The access network device may include a base station, a wireless local area network (WLAN) access point (AP), a wireless fidelity (WiFi) node, and the like. The base station may be referred to as a NodeB (NB), an evolved NodeB (eNB), the next generation NodeB (gNB), a new radio NodeB (NR NodeB), an access point, a relay base station (RBS), a serving base station (SBS), a base transceiver station (BTS), a radio base station, a radio transceiver, a basic service set (BSS), an extended service set (ESS), a home NodeB (HNB), a home evolved NodeB, a transmission reception point (TRP), or another proper term in the field. The base station is not limited to a specific technical term, provided that the same technical effect is achieved. It should be noted that in the embodiments of this application, only a base station in an NR system is used as an example for description, and a specific type of the base station is not limited.

The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function (PCRF) unit, an edge application server discovery function (EASDF), unified data management (UDM), a unified data repository (UDR), a home subscriber server (HSS), a centralized network configuration (CNC), a network repository function (NRF), a network exposure function (NEF), a local NEF (Local NEF or L-NEF), a binding support function (BSF), an application function (AF), and the like. It should be noted that in the embodiments of this application, only a core network device in the NR system is used as an example for description, and a specific type of the core network device is not limited.

To facilitate better understanding of the embodiments of this application, the following technical points are first described below.

### 1. Integrated Sensing and Communication

In the future, B5G and 6G wireless communication systems are expected to provide various high-precision sensing services, such as indoor positioning of robot navigation, Wi-Fi sensing of smart homes, and radar sensing of self-driving vehicles. Sensing and communication systems are usually designed separately and occupy different bands. Integrated sensing and communication (ISAC) enables sensing and communication systems to share the same band and hardware, thereby improving frequency efficiency and reducing hardware costs. ISAC will become a key technology in a future wireless communication system to support many important application scenarios. Typical applications of ISAC include navigation and obstacle avoidance of a self-driving vehicle, Wi-Fi-based indoor positioning and activity recognition, communication and sensing of an unmanned aircraft, extended reality (XR), radar and communication integration, and the like. Each application has different requirements, restrictions, and regulatory problems.

ISAC achieves integrated low-cost implementation of communication and sensing functions in a manner of hardware device sharing and a software definition function. Characteristics mainly include: a unified and simplified architecture, a reconfigurable and scalable function, and improved efficiency and reduced costs. Advantages of integrated sensing and communication mainly include three aspects: reduced device costs and sizes, improved spectrum utilization, and improved system performance.

Currently, a typical integrated sensing and communication scenario that is expected to be implemented by performing a technical upgrade based on a 5G communication system architecture is shown in Table 1.

TABLE 1
Typical scenarios of integrated sensing and communication

| Wireless sensing | | |
|---|---|---|
| category | Sensing function | Application scenario |
| Large-scale macro | Weather, air quality, and the like | Meteorology, agriculture, and |
| sensing type | | life services |
| | Traffic flow (intersections) and | Smart city, smart transportation, |
| | crowd flow (subway entrances) | and commercial services |
| | Animal activity and migration, | Animal husbandry, ecological |
| | and the like | environment protection, and the |
| | | like |
| | Target tracking, distance | Many application scenarios of a |
| | measurement, speed | conventional radar |
| | measurement, outlining, and the | |
| | like | |
| | Three-dimensional map | Intelligent driving, navigation, |
| | construction | and smart city |
| Short-range refined | Action and posture recognition | Smart interaction of |
| sensing type | | smartphones, gaming, and smart |
| | | home |
| | Heartbeat, breathing, and the like | Health and medical care |
| | Imaging, material detection, and | Security inspection, industry, and |
| | the like | the like |

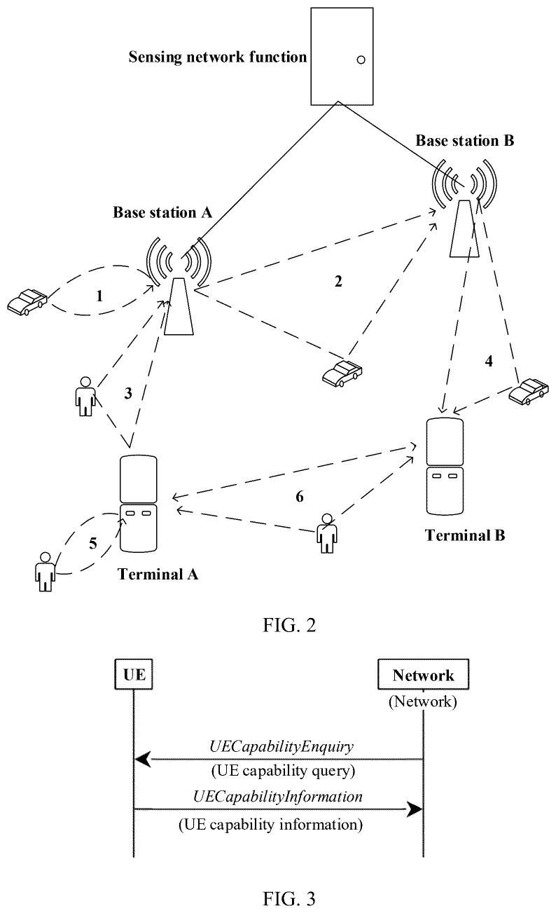

There are six basic sensing manners based on different sensing signal sending nodes and receiving nodes. As shown in FIG. 2, the following sensing manners are specifically included:

(1) Self-sending and self-receiving sensing of a base station: In this sensing manner, a base station A sends a sensing signal, and performs sensing measurement by receiving an echo of the sensing signal.

(2) Air-interface sensing between base stations: A base station B receives a sensing signal sent by the base station A, and performs sensing measurement.

(3) Uplink air-interface sensing: The base station A receives a sensing signal sent by a terminal A, and performs sensing measurement.

(4) Downlink air-interface sensing: A terminal B receives a sensing signal sent by the base station B, and performs sensing measurement.

(5) Self-sending and self-receiving sensing of a terminal: The terminal A sends a sensing signal, and performs sensing measurement by receiving an echo of the sensing signal.

(6) Sidelink sensing between terminals: The terminal B receives a sensing signal sent by the terminal A, and performs sensing measurement.

It should be noted that for each sensing manner in FIG. 2, one sensing signal sending node and one sensing signal receiving node are used as an example. In an actual system, one or more different sensing manners may be selected according to different sensing use cases and different sensing requirements, and there may be one or more sending nodes and one or more receiving nodes for each sensing manner. In an example, people and vehicles are used as sensing targets in FIG. 2, and it is assumed that none of the people and the vehicles carries or is mounted with a signal receiving/sending device. Sensing targets in an actual scenario are more abundant.

### 2. User Equipment (UE) Capability Exchange

In the NR protocol TS38.901, a UE capability exchange procedure is shown in FIG. 3.

In a first step, a network sends radio resource control (RRC) signaling UECapabilityEnquiry to the UE, so as to instruct the UE to report capability information. In the UECapabilityEnquiry signaling, a network side specifies a radio access technology (RAT) and a band that are required by the UE to report the capability information, so as to reduce an amount of information in UE capability reporting. The RAT and the band specified by the network side are referred to as a filter.

In a second step, the UE packages the capability information into a container corresponding to the RAT or the band based on the RAT and the band (that is, the filter) specified in the UECapabilityEnquiry, and reports the capability information to the network by using the RRC signaling UECapability Information.

For the signaling specifically used to organize the UE capability, based on different RATs specified in the UECapabilityEnquiry, the corresponding container in the UECapability Information includes the following content:

If a specified RAT is set to new radio (NR), the UE capability organizes the UE capability information by using UE-NR-Capability signaling.

If the specified RAT is set to new radio evolved-UMTS terrestrial radio access (NR-EUTRA), the UE capability organizes the UE capability information by using UE-MRDC-Capability signaling.

If the specified RAT is set to evolved-UMTS terrestrial radio access (EUTRA), the UE capability organizes the UE capability information by using UE-EUTRA-Capability signaling (as defined in TS36.331).

UE-NR-Capability is used as an example, and the following content is included:

{
UE-NR-Capability ::= SEQUENCE {

| | |
|---|---|
| accessStratumRelease | AccessStratumRelease, |
| pdcp-Parameters | PDCP-Parameters, |
| rlc-Parameters | RLC-Parameters OPTIONAL, |
| mac-Parameters | MAC-Parameters OPTIONAL, |
| phy-Parameters | Phy-Parameters, |
| rf-Parameters | RF-Parameters, |
| measAndMobParameters | MeasAndMobParameters OPTIONAL, |
| fdd-Add-UE-NR-Capabilities | UE-NR-CapabilityAddXDD-Mode OPTIONAL, |
| tdd-Add-UE-NR-Capabilities | UE-NR-CapabilityAddXDD-Mode OPTIONAL, |
| fr1-Add-UE-NR-Capabilities | UE-NR-CapabilityAddFRX-Mode OPTIONAL, |
| fr2-Add-UE-NR-Capabilities | UE-NR-CapabilityAddFRX-Mode OPTIONAL, |
| featureSets | FeatureSets OPTIONAL, |
| featureSetCombinations | SEQUENCE (SIZE (1..maxFeatureSetCombinations)) |
| | OF FeatureSetCombination OPTIONAL, |
| lateNonCriticalExtension | OCTET STRING OPTIONAL, |
| nonCriticalExtension | UE-NR-Capability-v1530 OPTIONAL |

}
}

Parameters PDCP-Parameters, RLC-Parameters, and MAC-Parameters are mainly used to include capability information of a radio access network (RAN) higher layer, and Phy-Parameters to FeatureSets are used to include capability information of a physical layer. For different bands, the NR organizes downlink and uplink capability information of the UE in FeatureSetDownlink and FeatureSetUplink under the FeatureSets directory. Further, for different component carriers (CC) of the same band, the NR organizes downlink and uplink capability information of the UE in FeatureSetDownlinkPerCC under FeatureSetDownlink and FeatureSetUplinkPerCC under FeatureSetUplink. Therefore, some capability information of the UE may be reported on a per-band or per-CC basis, so as to reduce overheads for exchanging the UE capability.

Some nouns used in the embodiments of this application are explained as follows:

### Explanation 1: Sensing Measurement Quantity

The sensing measurement quantity is a measurement quantity obtained by performing, by a receive end device of a sensing signal, signal processing on in-phase quadrature (IQ) channels of data that are obtained by performing operations such as down conversion, filtering, and analog-to-digital conversion (AD conversion) on a received signal. The sensing measurement quantity may include at least one of the following:
a first-level measurement quantity; a second-level measurement quantity; a third-level measurement quantity; and a fourth-level measurement quantity.

The first-level measurement quantity (a received signal/original channel information) includes a received signal/channel response complex result, an amplitude/phase, an I-channel/Q-channel and operation results thereof (operations include addition, subtraction, multiplication, and division, matrix addition, subtraction, and multiplication, matrix transposition, a trigonometric operation, a square root operation, a power operation, and the like, along with a threshold detection result, a maximum/minimum value extraction result, and the like of results of the foregoing operations; and the operations further include fast Fourier transform (FFT)/inverse fast Fourier transform (IFFT), discrete Fourier transform (DFT)/inverse discrete Fourier transform (IDFT), two-dimensional fast Fourier transform (2D-FFT), three-dimensional fast Fourier transform (3D-FFT), matched filtering, an autocorrelation operation, wavelet transform, digital filtering, and the like, along with a threshold detection result, a maximum/minimum value extraction result, and the like of results of the foregoing operations).

The second-level measurement quantity (a basic measurement quantity) includes a delay, Doppler, an angle, strength, and a multi-dimensional combination expression thereof.

The third-level measurement quantity (a basic attribute/state) includes a distance, a speed, an orientation, a spatial location, and an acceleration.

The fourth-level measurement quantity (an advanced attribute/state) includes: whether a target exists, a track, an action, an emotion, a vital sign, a quantity, an imaging result, weather, air quality, a shape, a material, and a component.

It should be noted that, according to different sensing use cases/scenarios and different sensing requirements, any one of the foregoing measurement quantities may be a sensing result corresponding to the sensing requirement, or may be an intermediate result that needs to be further processed to obtain the sensing result corresponding to the sensing requirement.

Explanation 2: Sensing Signal Power and Sensing Signal to Noise Ratio (SNR)/Sensing Signal to Interference Plus Noise Ratio (SINR) A method for obtaining the sensing signal power may be at least one of the following:

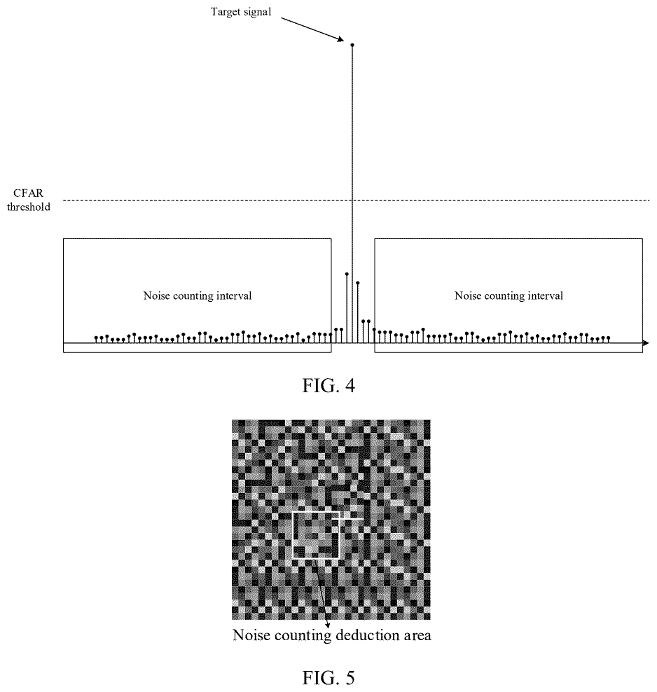

Constant false alarm rate (CFAR) detection is performed based on a one-dimensional delay map obtained through fast-time dimension FFT processing of an echo signal, and a sample value point with a largest amplitude whose CFAR exceeds a threshold is used as a target sample value point, and the amplitude of the target sample value point is used as a target signal amplitude, as shown in FIG. 4.

CFAR is performed based on a one-dimensional Doppler map obtained through slow-time dimension FFT processing of the echo signal, a sample value point with a largest amplitude whose CFAR exceeds a threshold is used as a target sample value point, and the amplitude of the target sample value point is used as a target signal amplitude, as shown in FIG. 4.

CFAR is performed based on a two-dimensional delay-Doppler map obtained through 2D-FFT processing of the echo signal, a sample value point with a largest amplitude whose CFAR exceeds a threshold is used as a target sample value point, and the amplitude of the target sample value point is used as a target signal amplitude, as shown in FIG. 4.

CFAR is performed based on a three-dimensional delay-Doppler-angle map obtained through 3D-FFT processing of the echo signal, a sample value point with a largest amplitude whose CFAR exceeds a threshold is used as a target sample value point, and the amplitude of the target sample value point is used as a target signal amplitude.

In addition to using the sample value point with the largest amplitude whose CFAR exceeds the threshold as the target sample value point, a method for determining the target signal amplitude may alternatively be using an average value of the sample value point with the largest amplitude whose CFAR exceeds the threshold and several nearest sample value points exceeding the threshold as the target signal amplitude.

A method for obtaining the sensing SNR/sensing SINR may be as follows:

Constant false-alarm rate (CFAR) detection is performed based on a one-dimensional delay map obtained through fast-time dimension FFT processing of the echo signal, a sample value point with a largest amplitude whose CFAR exceeds a threshold is used as a target sample value point, the amplitude of the target sample value point is used as a target signal amplitude, all sample value points other than those ±ε sample value points away from a location of the target sample value point in the one-dimensional map are used as interference/noise sample value points, and an average interference/amplitude of the interference/noise sample value points is counted as an interference/noise signal amplitude, as shown in FIG. 4. Finally, the SNR/SINR is calculated by using the target signal amplitude and the interference/noise signal amplitude.

CFAR is performed based on a one-dimensional Doppler map obtained through slow-time dimension FFT processing of the echo signal, a sample value point with a largest amplitude whose CFAR exceeds a threshold is used as a target sample value point, the amplitude of the target sample value point is used as a target signal amplitude, all sample value points other than those ±η sample value points away from a location of the target sample value point in the one-dimensional map are used as interference/noise sample value points, and an average amplitude of the interference/noise sample value points is counted as an interference/noise signal amplitude. Finally, the SNR/SINR is calculated by using the target signal amplitude and the interference/noise signal amplitude.

CFAR is performed based on a two-dimensional delay-Doppler map obtained through 2D-FFT processing of the echo signal, a sample value point with a largest amplitude whose CFAR exceeds a threshold is used as a target sample value point, the amplitude of the target sample value point is used as a target signal amplitude, all sample value points other than those ±ε (a fast-time dimension) and ±η (a slow-time dimension) sample value points away from the target sample value point in the two-dimensional map are used as interference/noise sample value points, and an average amplitude of the interference/noise sample value points is counted as an interference/noise signal amplitude, as shown in FIG. 5. Finally, the SNR/SINR is calculated by using the target signal amplitude and the interference/noise signal amplitude.

CFAR is performed based on a three-dimensional delay-Doppler-angle map obtained through 3D-FFT processing of the echo signal, a sample value point with a largest amplitude whose CFAR exceeds a threshold is used as a target sample value point, the amplitude of the target sample value point is used as a target signal amplitude, all sample value points other than those ±ε (a fast-time dimension), ±η (a slow-time dimension), and ±δ (an angle dimension) sample value points away from the target sample value point in the three-dimensional map are used as interference/noise sample value points, and an average amplitude of the interference/noise sample value points is counted as an interference/noise signal amplitude. Finally, the SNR/SINR is calculated by using the target signal amplitude and the interference/noise signal amplitude.

In addition to using the sample value point with the largest amplitude whose CFAR exceeds the threshold as the target sample value point, a method for determining the target signal amplitude may alternatively be using an average value of the sample value point with the largest amplitude whose CFAR exceeds the threshold and several nearest sample value points exceeding the threshold as the target signal amplitude.

A method for determining an interference/noise sample value point may alternatively be performing further selection based on the determined interference/noise sample value points. A selection method is as follows: For the one-dimensional delay map, several sample value points near a delay of 0 are removed, and remaining interference/noise sample value points are used as noise sample value points; for the one-dimensional Doppler map, several sample value points near Doppler of 0 are removed, and remaining interference/noise sample value points are used as interference/noise sample value points; for the two-dimensional delay-Doppler map, several points near a delay of 0 and interference/noise sample value points in a strip range formed by all Doppler ranges are removed, and remaining noise sample value points are used as interference/noise sample value points; or for the three-dimensional delay-Doppler-angle map, several points near a time dimension of 0 and interference/noise sample value points in a slice range formed by all Doppler ranges and all angle ranges are removed, and remaining interference/noise sample value points are used as interference/noise sample value points.

### Explanation 3: Sensing Function Network Element

The sensing function network element may also be referred to as a sensing network element or a sensing network function, and may be located on a RAN side or a core network side. The sensing function network element refers to a network node that is in a core network and/or in a RAN and that is responsible for at least one function of sensing request processing, sensing resource scheduling, sensing information exchange, sensing data processing, and the like. The sensing function network element may be upgraded based on an AMF or a location management function (LMF) in a 5G network, or may be another network node or a newly defined network node. Specifically, a functional feature of the sensing function network element may include at least one of the following:

Target information is exchanged with a wireless signal sending device and/or a wireless signal measurement device (including a target terminal, a serving base station of a target terminal, or a base station associated with a target area), where the target information includes a sensing processing request, a sensing capability, sensing assistance data, a sensing measurement quantity type, sensing resource configuration information, and the like, to obtain a target sensing result or a value of a sensing measurement quantity (an uplink measurement quantity or a downlink measurement quantity) sent by the wireless signal measurement device. The wireless signal may also be referred to as a sensing signal.

A sensing method to be used is determined based on factors such as a type of a sensing service, sensing service consumer information, required sensing quality of service (QoS) requirement information, a sensing capability of the wireless signal sending device, and a sensing capability of the wireless signal measurement device. The sensing method may include: A base station A performs sending and a base station B performs receiving, a base station performs sending and a terminal performs receiving, the base station A independently performs sending and independently performs receiving, the terminal performs sending and the base station performs receiving, the terminal independently performs sending and independently performs receiving, a terminal A performs sending and a terminal B performs receiving, or the like.

A sensing device for serving the sensing service is determined based on factors such as the type of the sensing service, the sensing service consumer information, the required sensing QoS requirement information, the sensing capability of the wireless signal sending device, and the sensing capability of the wireless signal measurement device, where the sensing device includes the wireless signal sending device and/or the wireless signal measurement device.

Overall coordination and scheduling of resources required for the sensing service are managed. For example, sensing resources of the base station and/or the terminal are correspondingly configured.

Data processing is performed on the value of the sensing measurement quantity, or calculation is performed to obtain a sensing result. Further, the sensing result is verified, sensing precision is estimated, and so on.

In a related technology, exchange of a device capability involves only exchange of a communication-related capability. Because only the communication-related capability is exchanged, a type of a capability exchanged between devices is undiversified. Consequently, performance of exchange between devices is poor. In the embodiments of this application, the first communication device reports sensing-related capability information to the second communication device, so that exchange of a device capability extends to exchange of a sensing capability. This avoids an undiversified type of a capability exchanged between devices, thereby improving performance of exchange between devices, and improving sensing performance through sensing capability exchange.

With reference to the accompanying drawings, the following describes in detail, by using some embodiments and application scenarios thereof, the information sending method and apparatus, the information receiving method and apparatus, and the communication device that are provided in the embodiments of this application.

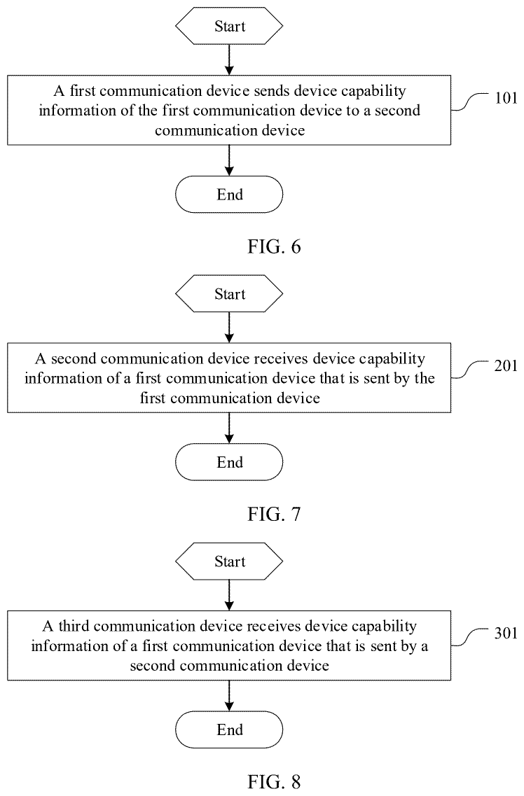

Referring to FIG. 6, FIG. 6 is a flowchart of an information sending method according to an embodiment of this application. As shown in FIG. 6, the information sending method includes the following steps.

Step 101: A first communication device sends device capability information of the first communication device to a second communication device.

The device capability information of the first communication device includes at least one piece of the following sensing capability information:
indication information used to indicate whether sensing is supported;
sensing mobility management capability information;
sensing reporting capability information;
sensing information processing capability information;
sensing signal support capability information;
sensing link adaptation capability information; and
sensing assistance support capability information.

The device capability information may include sensing capability information, and the device capability information may further include communication capability information. The sensing capability information may include at least one of the following: indication information used to indicate whether sensing is supported; sensing mobility management capability information; sensing reporting capability information; sensing information processing capability information; sensing signal support capability information; sensing link adaptation capability information; and sensing assistance support capability information.

The indication information used to indicate whether sensing is supported may be indication information used to indicate whether the first communication device has a capability of executing a sensing service.

The sensing information processing capability information may be used to indicate a capability that is supported by the device and that is related to sensing signal processing and/or sensing data processing.

The sensing link adaptation capability information may be indication information of a capability related to link adaptation, and is used to indicate whether the device has a link adaptation adjustment capability of configuring resources such as time domain, frequency domain, an antenna port, or a transmit power of the sensing signal based on the sensing measurement quantity or the sensing result.

The sensing assistance support capability information may be indication information of a capability related to sensing assistance information.

It should be noted that the first communication device may be UE, or may be a base station. The second communication device may be a network side device (including a base station, a core network device, and the like).

It should be noted that in a next-generation communication system (for example, 6G communication), in addition to executing a communication service, the communication device (including the UE and the base station) needs to execute a sensing service, that is, integrated sensing and communication. Therefore, exchange of the sensing capability information is indispensable. In an existing protocol, exchange of a device capability involves only exchange of a communication-related capability of the UE, and does not involve exchange of a sensing-related capability of the UE. In addition, the existing protocol does not involve exchange of sensing capability information of the base station, either. Therefore, in the related technology, the method for exchanging the device capability information cannot effectively support integrated sensing and communication.

In the related technology, the method for exchanging the UE capability information involves only exchange of the communication-related capability of the UE, and does not involve exchange of the sensing-related capability of the UE. In addition, the related technology does not involve exchange of the sensing capability information of the base station, either. In the embodiments of this application, exchange of the sensing-related capability of the UE can be implemented, and exchange of the sensing-related capability of the base station can be further implemented.

In the embodiments of this application, the first communication device sends device capability information of the first communication device to the second communication device, where the device capability information of the first communication device includes at least one piece of the following sensing capability information: indication information used to indicate whether sensing is supported; sensing mobility management capability information; sensing reporting capability information; sensing information processing capability information; sensing signal support capability information; sensing link adaptation capability information; and sensing assistance support capability information. In this way, the first communication device reports sensing-related capability information to the second communication device, so that exchange of the device capability information extends from exchange of communication capability information only in a related technology to exchange of the device capability information including sensing capability information, thereby avoiding an undiversified type of a capability exchanged between devices, and supporting integrated sensing and communication.

Optionally, the device capability information of the first communication device is carried in a first information element, and the first information element is used to indicate at least one of communication capability information and sensing capability information.

The first information element (IE) may be an existing information element (IE), or may be a newly added information element. This is not limited in the embodiments.

It should be noted that, when being used for exchange of the sensing capability information of the UE, a sensing capability information parameter may be newly added based on an existing signaling structure of the UE capability, so as to support exchange of the sensing capability information. The newly-added sensing capability information parameter may be deployed in the first information element. The first information element may include at least one of the following:
UE-NR-Capability or UE-MRDC-Capability;
UE-NR-Capability->Phy-Parameters;
UE-MRDC-Capability->Phy-ParametersMRDC;
UE-NR-Capability->RF-Parameters;
UE-MRDC-Capability->RF-ParametersMRDC;
UE-NR-Capabilibty->MeasAndMobParameters;
UE-MRDC-Capability->MeasAndMobParametersMRDC;
UE-NR-Capability->UE-NR-Capability AddXDD-Mode;
UE-MRDC-Capability->UE-MRDC-Capability AddXDD-Mode;
UE-NR-Capability->UE-NR-Capability AddFRX-Mode;
UE-MRDC-Capability->UE-MRDC-Capability AddFRX-Mode;
UE-NR-Capabilibty->FeatureSets;
UE-NR-Capabilibty>FeatureSets->FeatureSetDownlink; optionally, per-band capability information of the UE for receiving a sensing signal is under this path;
UE-NR-Capabilibty>FeatureSets->FeatureSetUplink; optionally, per-band capability information of the UE for sending a sensing signal is under this path;
UE-NR-Capabilibty>FeatureSets->FeatureSetDownlink->FeatureSetDownlinkPerCC; optionally, per-CC capability information of the UE for receiving a sensing signal is under this path;
UE-NR-Capabilibty>FeatureSets->FeatureSetDownlink->FeatureSetUplinkPerCC; optionally, per-CC capability information of the UE for sending a sensing signal is under this path;
evolved versions of the foregoing information elements, for example, UE-NR-Capability-v1530 or FeatureSetUplink-v1540.

It should be noted that, UE-NR-Capability is used as an example, and the first information element may be UE-NR-Capability. In this case, the sensing capability information parameter of the UE may be supplemented to UE-NR-Capability. UE-MRDC-Capability->Phy-ParametersMRDC is used as an example, and the first information element may be Phy-ParametersMRDC under UE-MRDC-Capability. In this case, the sensing capability information parameter of the UE may be supplemented to Phy-ParametersMRDC.

It should be noted that, when being used for exchange of the sensing capability information of the base station, a signaling structure of the sensing capability information of the base station may be defined based on a signaling structure similar to the signaling structure of the sensing capability information of the UE, and the signaling structure includes a sensing capability information parameter, so as to implement exchange of the sensing capability information of the base station. Clearly, due to use for the exchange of the sensing capability information of the base station, the specific signaling name is different from the foregoing signaling name used for the exchange of the sensing capability information of the UE.

In the embodiments, the existing signaling architecture of the UE capability is extended to support exchange of the sensing capability information of the base station/UE.

In the embodiments, the exchange of the sensing capability information may be supplemented or evolved based on the existing signaling structure for the exchange of the UE capability information, so as to be used for the exchange of the sensing capability information of the UE and the base station.

In the embodiments of this application, the existing signaling architecture for the exchange of the capability information of the UE is extended to support exchange of the sensing capability of the UE, and the signaling for exchange of the sensing capability information of the base station is defined with reference to the signaling architecture for the exchange of the sensing capability information of the UE, thereby helping select a proper base station to participate in a sensing service.

Optionally, the sensing mobility management capability information is used to indicate at least one of the following:
whether sensing mobility management is supported;
a measurement quantity supported by the sensing mobility management;
a measurement object supported by the sensing mobility management; and
a measurement event supported by the sensing mobility management.

The sensing mobility management capability information may be used to indicate whether sensing mobility management is supported. Indicating whether sensing mobility management is supported may be indicating whether mobility management of sensing is supported. Herein, sensing mobility management refers to an operation performed for the purposes of performance and continuity of sensing when a relative movement between a device and a sensing object is caused by movement of the device and/or the sensing object, including link adaptation of a sensing signal configuration, switching of a sensing device, and the like.

The sensing mobility management capability information may be used to indicate a measurement quantity supported by the sensing mobility management. The measurement quantity supported by the sensing mobility management may include at least one of the following: a measurement quantity related to communication mobility management, a sensing measurement quantity, a sensing signal power, a sensing SNR/sensing SINR, and an operation result of the foregoing measurement quantities.

The sensing mobility management capability information may be used to indicate a measurement object supported by the sensing mobility management. The measurement object supported by the sensing mobility management may include at least one of the following: a synchronization signal block (SSB) and a channel state information reference signal (CSI-RS) in the communication mobility management; other reference signals (for example, a demodulation reference signal (DMRS) and a positioning reference signal (PRS)); a newly designed reference signal for sensing in 5.5G/6G; and communication data used as a sensing signal.

The sensing mobility management capability information may be used to indicate a measurement event supported by the sensing mobility management. The communication mobility management includes an event A (eventA1 to eventA6 in the NR system) and an event B (multi-RAT dual connectivity (Multi-RAT dual connectivity, MRDC), eventB1 to eventB2), and is mainly determined based on a threshold of reference signal received power (RSRP)/reference signal received quality (RSRQ)/SINR. In addition to including an existing event of communication mobility management, the measurement event of the sensing mobility management may further include an event that is determined based on a threshold of another measurement quantity in the measurement quantity supported by the sensing mobility management, for example, an event determined based on a threshold of a delay/distance of the sensing object, an event determined based on a threshold of Doppler/a speed of the sensing object, and an event determined based on a threshold of a location of the sensing object.

Optionally, the measurement quantity supported by the sensing mobility management includes at least one of the following: a measurement quantity related to communication mobility management; a sensing measurement quantity; a sensing signal power; a sensing signal to interference plus noise ratio SINR; a sensing signal to noise ratio SNR; and an operation result of a target operation performed by using a target measurement quantity.

The measurement quantity related to communication mobility management may include RSRP, RSRQ, SINR, and the like.

The sensing measurement quantity is a measurement quantity obtained by performing, by a receive end device of a sensing signal, signal processing on IQ channels of data that are obtained by performing operations such as down conversion, filtering, and AD conversion on a received signal. For details, refer to explanation 1: sensing measurement quantity.

For the sensing signal power, the sensing signal to interference plus noise ratio SINR, and the sensing signal to noise ratio SNR, refer to explanation 2: sensing signal power and sensing signal to noise ratio.

The target measurement quantity may be at least one of a measurement quantity related to communication mobility management, a sensing measurement quantity, a sensing signal power, a sensing SINR, and a sensing SNR. The target operation may be at least one of the following operations: a variance/standard deviation, a root mean square error (RMSE), a state estimation error covariance, a state prediction error covariance, and the like. The state estimation error covariance and the state prediction error covariance may be a quantity obtained by using a Kalman filtering operation.

Optionally, the sensing reporting capability information is used to indicate one of the following:
whether a physical uplink control channel (PUCCH) reporting a sensing measurement quantity is supported;
whether the PUCCH reporting a sensing result is supported;
whether a physical uplink shared channel (PUSCH) reporting a sensing measurement quantity is supported;
whether the PUSCH reporting a sensing result is supported; and
a supported reporting manner of the sensing measurement quantity or the sensing result, where the reporting manner includes at least one of periodic reporting, semi-persistent reporting, and aperiodic reporting.

In an implementation, the sensing reporting capability information is used to indicate whether the PUCCH reporting the sensing measurement quantity/sensing result (is supported). Further, a reporting manner of the indication that the PUCCH reports the sensing measurement quantity/sensing result may be at least one of periodic, semi-persistent, and aperiodic.

In an implementation, the sensing reporting capability information is used to indicate whether the PUSCH reporting the sensing measurement quantity/sensing result (is supported). Further, a reporting manner of the indication that the PUSCH reports the sensing measurement quantity/sensing result may be at least one of periodic, semi-persistent, and aperiodic.

Optionally, the sensing information processing capability information is used to indicate at least one of the following:
a supported sensing signal processing type;
a sensing data processing capability;
whether conversion from the sensing measurement quantity to the sensing result is supported;
a coherent processing time supported by performing sensing signal processing;
a data computing capability of a sensing service;
a data storage capability of the sensing service;
whether a sensing requirement processing capability is available; and
whether a sensing result fusion capability is available.

The sensing information processing capability information is used to indicate a supported sensing signal processing type, and may be a capability indication related to sensing signal processing. Sensing signal processing refers to a process of converting IQ channels of data of a received signal into a sensing measurement quantity. On the one hand, the supported sensing signal processing type is associated with a supported measurement quantity. A corresponding type of sensing signal processing needs to be supported to obtain a specified measurement quantity. On the other hand, to obtain the same measurement quantity, different sensing signal processing types correspond to different sensing QoS, for example, different sensing signal processing types have different resolution or different operation delays. The sensing information processing capability information is used to indicate a supported sensing signal processing type, and may indicate a type of a sensing signal processing algorithm supported by the device.

The sensing information processing capability information may be used to indicate whether conversion from the sensing measurement quantity to the sensing result is supported. Conversion from the sensing measurement quantity to the sensing result may be conversion from the sensing measurement quantity to the sensing result. For example, for a sensing mode in which A performs sending and B performs receiving, a receive end extracts a delay, Doppler, and an angle of a path corresponding to a sensing object from a received signal. However, if these measurement quantities are converted to a location of the sensing object, further processing needs to be performed with reference to assistance information such as a location of a transceiving node of the sensing signal, an orientation of an antenna panel, and a motion state. The sensing information processing capability information may be used to indicate whether the device has a capability of converting the sensing measurement quantity to the sensing result.

The sensing information processing capability information may be used to indicate a coherent processing time supported by performing sensing signal processing. In a sensing service, a time range spanned in time domain by performing one-time sensing signal processing to obtain a sensing signal processed for a measurement quantity is referred to as a coherent processing time. Before the sensing signal is processed, IQ channels of data in the corresponding time range need to be stored, and then corresponding signal processing is performed. Therefore, there are two requirements for a device to support a specific length of coherent processing time: One is a requirement for a cache or storage capability, and the other is a requirement for a computing capability. The sensing information processing capability information may be used to indicate whether the device supports a specific length of coherent processing time, for example, whether the device supports a 10 ms coherent processing time (which may be, for example, represented by a cpi 10 ms field), whether the device supports a 20 ms coherent processing time, whether the device supports a 50 ms coherent processing time, and whether the device supports a 100 ms coherent processing time. Clearly, if a longer coherent processing time is supported, a shorter coherent processing time can certainly be supported.

The sensing information processing capability information may be used to indicate at least one of a data computing capability of the sensing service and a data storage capability of the sensing service. The data storage capability of the sensing service may alternatively be described as a data cache capability of the sensing service. A supported sensing signal processing/sensing data processing type and a supported coherent processing time may be basically classified into a data computing capability and a data storage capability that are supported by the device. Therefore, the device may further report a data computing capability and a data storage capability that can be used for the sensing service. The data computing capability that is of the device and that can be used for the sensing service may be divided into several levels, the data storage capability that is of the device and that can be used for the sensing service may be divided into several levels, and a specific quantity of bits is used to indicate a supported level. The sensing information processing capability information may be used to indicate a data computing capability level and/or a data storage capability level of the device. The storage capability may alternatively be described as a cache capability.

The sensing information processing capability information may be used to indicate whether a sensing requirement processing capability is available. Indicating whether a sensing requirement processing capability is available may be an indication of a capability related to higher layer processing of sensing. The sensing requirement processing refers to a process in which a requirement such as sensing QoS in the sensing requirement information is mapped to a sensing signal configuration required for executing a sensing service. For example, the device may convert resolution information of distance measurement and speed measurement in the sensing requirement information to a time-frequency domain signal configuration of the sensing signal.

The sensing information processing capability information may be used to indicate whether a sensing result fusion capability is available. Indicating whether a sensing result fusion capability is available may be an indication of a capability related to higher layer processing of sensing. Sensing result fusion is a process of fusing a plurality of sensing results into one sensing result. The plurality of sensing results may be obtained by a plurality of devices by executing a sensing service, or may be obtained by using a plurality of types of sensing manners (communication and sensing and sensors of various RATs) on one device. For example, each of fusion of communication and sensing and camera sensing, and fusion of NR communication and sensing and Wi-Fi communication and sensing may be represented by one bit. A corresponding bit ‘1’ indicates that the type of sensing fusion is supported.

Optionally, the supported sensing signal processing type includes a supported sensing signal processing algorithm, and the supported sensing signal processing algorithm includes at least one of the following: Fourier transform; a spectral analysis operation of a non-uniform sequence; a high resolution algorithm; a constant false alarm detection algorithm; and an artificial intelligence (AI) pattern recognition algorithm.

Optionally, the sensing data processing capability includes at least one of the following: whether motion compensation is supported; whether a sensing object trajectory management capability is available; and a supported multi-target sensing capability.

The supported sensing signal processing algorithm may include Fourier transform, and the Fourier transform algorithm may include 1D-FFT/2D-FFT/3D-FFT. The supported sensing signal processing algorithm may include a spectral analysis operation of a non-uniform sequence, for example, non-uniform FFT. The supported sensing signal processing algorithm may include a high resolution algorithm, such as a multiple signal classification (MUSCI) algorithm, and estimation of signal parameters using rotational invariance techniques (ESPRIT).

The sensing data processing capability may include whether motion compensation is supported, and whether motion compensation is supported may represent a capability indicating whether the device can eliminate impact of a motion state of the device on a sensing measurement quantity or a sensing result when the device is in a motion state.

The sensing data processing capability may include a supported multi-target sensing capability. The supported multi-target sensing capability may be a capability of the device to support simultaneous running of a plurality of sensing service processes. One sensing service process corresponds to sensing of one sensing object, or sensing of a specified spatial range. The supported multi-target sensing capability may be used to indicate a maximum quantity of targets supported by the device.

Optionally, the sensing signal support capability information is used to indicate at least one of the following:
a sensing signal transceiving capability;
a sensing beam support capability;
a multi-node collaboration sensing capability;
a multiple input multiple output (MIMO) sensing capability; and
a multi-radio access technology multi-RAT sensing capability.

The sensing signal support capability information may be used to indicate a multi-node collaboration sensing capability. The multi-node collaboration sensing capability may be a capability related to multi-node collaboration sensing. In some scenarios, it is required that one device sends a sensing signal and a plurality of devices receive the sensing signal, or a plurality of devices send a sensing signal and one device receives the sensing signal, or a plurality of devices send a sensing signal and a plurality of devices receive the sensing signal, so as to execute a sensing service. In this case, a sensing node needs to have a multi-node collaboration sensing capability of sending a sensing signal to a plurality of devices or receiving a sensing signal sent by a plurality of devices.

The sensing signal support capability information may be used to indicate a MIMO sensing capability, and the MIMO sensing capability may be a capability related to MIMO sensing.

The sensing signal support capability information may be used to indicate a multi-RAT sensing capability. The multi-RAT sensing capability may be a capability related to multi-RAT sensing.

Optionally, the sensing signal transceiving capability includes at least one of the following: whether receiving a sensing signal is supported; whether transmitting a sensing signal is supported; whether receiving and transmitting a sensing signal is supported; and whether receiving and transmitting sensing signals at the same time are supported.

Optionally, the sensing beam support capability includes at least one of the following: a supported beam saltus; and a supported beam quantity.

Optionally, the multi-node collaboration sensing capability includes at least one of the following: a maximum quantity of ports for transmitting a sensing signal; and a maximum quantity of ports for receiving a sensing signal.

Optionally, the MIMO sensing capability includes at least one of the following: whether MIMO sensing is supported; a supported maximum quantity of related antenna ports; a supported antenna arrangement; whether switching between MIMO sensing and non-MIMO sensing is supported; and a supported MIMO sensing manner.

Optionally, the multi-RAT sensing capability includes at least one of the following: a radio access technology RAT type that supports a sensing service; and whether multi-RAT collaboration sensing is supported.

The sensing beam support capability may include a supported beam saltus. The beam saltus is important for communication because several beams are used to cover a specific range. However, for sensing, in addition to a specific range to be covered, a beam direction can be flexibly adjusted in the range. The beam saltus is a minimum angle interval between adjacent beams during adjustment of the beam direction. When a value of the beam saltus is small, the device can perform fine tracking on a sensing target. The sensing signal support capability information may be used to indicate a minimum quantity of beam saltuses indicated by the device. If the device supports a specific value of beam saltus, the device can certainly support a larger value of beam saltus.

The sensing beam support capability may include a supported quantity of beams. The supported quantity of beams may represent that a plurality of beams respectively sense a plurality of targets at the same time, and the sensing signal support capability information may be used to indicate a maximum quantity of beams supported by the device at the same time.

The multi-node collaboration sensing capability may be used to indicate a capability of the device to send a sensing signal to a plurality of devices or to receive a sensing signal sent by a plurality of devices, including:
a maximum quantity of ports for transmitting a sensing signal: One or more ports correspond to a receive end device of one sensing signal; and
a maximum quantity of ports for receiving a sensing signal: One or more ports correspond to a transmit end device of one sensing signal.

The MIMO sensing capability may include a supported maximum quantity of related antenna ports. The supported maximum quantity of related antenna ports may be a supported maximum quantity of related independent radio frequency channels.

The MIMO sensing capability may include an antenna arrangement that supports MIMO sensing. The supported antenna arrangement may include a half-wavelength spacing linear uniform arrangement, and/or another distribution. For example, the another distribution may be provided by giving an ID in an antenna arrangement pattern set.

The MIMO sensing capability may include whether switching between MIMO sensing and non-MIMO sensing is supported. Angle resolution of MIMO sensing is high, and an action distance of non-MIMO sensing is long.

The MIMO sensing capability may include a supported MIMO sensing manner. The supported MIMO sensing manner may include at least one of the following: time division multiplexing (TDM), frequency division multiplex (FDM), Doppler division multiplex (DDM), and code division multiplexing (CDM).

The multi-RAT sensing capability may include a RAT type that supports a sensing service. The sensing signal support capability information may be used to indicate a RAT type that supports the sensing service. For example, each of RATs such as evolved universal terrestrial radio access (E-UTRA), NR, 6G, and Wi-Fi is indicated by one bit. A corresponding bit ‘1’ indicates that sensing of the RAT is supported.

The multi-RAT sensing capability may include whether multi-RAT collaboration sensing is supported. For example, the sensing signal support capability information may be used to indicate whether E-UTRA and NR collaboration sensing is supported, or whether Wi-Fi and NR collaboration sensing is supported.

Optionally, the sensing assistance support capability information is used to indicate at least one of the following:
whether obtaining device state information is supported;
whether execution of a sensing service is allowed; and
a capability of an equipped sensor.

The sensing assistance support capability information may be used to indicate whether obtaining device state information is supported. The device state information may include at least one of the following: a device location, a posture (an antenna panel orientation), and a moving speed (including a speed size and a speed direction).

The sensing assistance support capability information may be used to indicate whether execution of a sensing service is allowed, that is, indicate a sensing permission. For example, the sensing assistance support capability information may be used to indicate whether use for execution of a sensing service is currently allowed (for example, a sensing permission set by a mobile phone holder).

The sensing assistance support capability information may be used to indicate a capability of an equipped sensor. For example, the sensing assistance support capability information may be indication information of information about the equipped sensor. The equipped sensor may be a device or module, other than communication and sensing, that can be used to perform sensing, such as a camera or a millimeter wave radar. The indication information of the information about the equipped sensor may include at least one of the following: indication information of a type of the sensor; and indication information of a performance parameter of the sensor. The indication information of the performance parameter of the sensor may be simplified into a level that represents sensing performance. For example, the performance of the camera is divided into several levels (preset levels) based on resolution, and in this case, a corresponding level is reported.

Optionally, before the sending, by a first communication device, device capability information of the first communication device to a second communication device, the method further includes:
receiving, by the first communication device, a first request sent by the second communication device, where the first request includes a first identifier, and the first identifier includes at least one of the following: a communication capability identifier; and a sensing capability identifier.

The communication capability identifier is used to indicate to report communication capability information, and the sensing capability identifier is used to indicate to report sensing capability information.

After receiving the first request sent by the second communication device, the first communication device may send, to the second communication device, the device capability information of the first communication device corresponding to the first identifier. In a case that the first identifier includes the communication capability identifier, the first communication device may report the communication capability information to the second communication device. In a case that the first identifier includes a sensing capability identifier, the first communication device may report sensing capability information to the second communication device. In a case that the first identifier includes the communication capability identifier and the sensing capability identifier, the first communication device may report the communication capability information and the sensing capability information to the second communication device.

In this implementation, the first communication device receives a first request sent by the second communication device, where the first request includes a first identifier, and the first identifier includes at least one of the following: a communication capability identifier; and a sensing capability identifier. The first identifier may be used as a filter, so that reporting of the communication capability information and the sensing capability information can be filtered by using the first identifier.

Optionally, in a case that the first identifier includes a sensing capability identifier, the first request further includes a second identifier, where the second identifier is used to indicate to report sensing capability information associated with at least one of the following objects: a sensing action; a service type of integrated sensing and communication; a RAT of integrated sensing and communication; and a band of integrated sensing and communication.

After receiving the first request sent by the second communication device, the first communication device may send, to the second communication device, the device capability information of the first communication device corresponding to the second identifier. In an example in which an object indicated by the second identifier is a sensing action, the first communication device may report, to the second communication device, sensing capability information associated with the sensing action indicated by the second identifier. For example, the object indicated by the second identifier is transmitting a sensing signal in the sensing action, and the first communication device may report, to the second communication device, sensing capability information associated with transmitting a sensing signal. In an example in which the object indicated by the second identifier is a service type of integrated sensing and communication, the first communication device may report, to the second communication device, sensing capability information associated with the service type of integrated sensing and communication indicated by the second identifier. In an example in which the object indicated by the second identifier is a RAT of integrated sensing and communication, the first communication device may report, to the second communication device, sensing capability information associated with the RAT of integrated sensing and communication indicated by the second identifier. In an example in which the object indicated by the second identifier is a band of integrated sensing and communication, the first communication device may report, to the second communication device, sensing capability information associated with the band of integrated sensing and communication indicated by the second identifier. The second identifier may be used as a filter, so that reporting of the sensing capability information can be filtered.

In addition, for the service type of integrated sensing and communication, if a protocol includes a specific sensing use case, the sensing capability information may be filtered according to the sensing use case. For example, typical sensing use cases include: radar detection, user positioning and tracking, three-dimensional reconstruction, weather/air quality detection, human flow/vehicle flow detection, vital sign detection (respiration/heartbeat), and action recognition. In this case, the sensing capability information may be filtered according to the typical sensing use cases. In addition to filtering the sensing capability information per sensing use case, the typical sensing use cases may be extracted and classified into categories based on commonalities of the typical sensing use cases, and may be classified into a radar category and a pattern recognition category.

The radar category indicates that the device has a capability of performing sensing of the radar category, and includes, for example, use cases such as radar detection, user positioning and tracking, and three-dimensional reconstruction.

The pattern recognition category indicates that the device has a capability of performing sensing of the pattern recognition category, and includes, for example, use cases such as weather/air quality detection, human flow/vehicle flow detection, vital sign detection, and action recognition.

For example, if the service type of integrated sensing and communication indicated by the second identifier includes the “radar category”, the device needs to report only a sensing capability information subset related to the sensing use cases of the radar category.

In addition, for the RAT of integrated sensing and communication, exchange of the sensing capability information may alternatively be filtered based on the RAT. To be specific, the RAT of integrated sensing and communication indicated by the second identifier may include at least one of the following: E-UTRA, NR, 6G, and Wi-Fi.

In addition, for the band of integrated sensing and communication, exchange of the sensing capability information may alternatively be filtered based on the band.

In addition, the sensing action may include at least one of transmitting a sensing signal, receiving a sensing signal, transmitting or receiving a sensing signal, transmitting and receiving sensing signals at the same time, and processing a sensing signal.

It should be noted that, when the sensing capability information may be organized under a corresponding directory path, each directory path is associated with a specific filter (the first identifier and/or the second identifier). For example, if a filter associated with a directory path (for example, specific FeatureSetDownlink under UE-NR-Capabilibty>FeatureSets) of one piece of sensing capability information is the second identifier and an object indicated by the second identifier is “transmitting a sensing signal” in the foregoing sensing action, it indicates that the sensing capability information under the directory path is applicable to transmitting a sensing signal by the device.

In this implementation, in a case that the first identifier includes a sensing capability identifier, the first request further includes a second identifier, where the second identifier is used to indicate to report sensing capability information associated with at least one of the following objects: a sensing action; a service type of integrated sensing and communication; a RAT of integrated sensing and communication; and a band of integrated sensing and communication. Therefore, reporting of the sensing capability information can be further filtered by using the second identifier.

Optionally, the sensing action includes at least one of the following:
transmitting a sensing signal;
receiving a sensing signal;
transmitting or receiving a sensing signal;
transmitting and receiving sensing signals at the same time; and
processing a sensing signal.

The sensing action may include transmitting a sensing signal, and the sensing capability information associated with transmitting a sensing signal may indicate a corresponding sensing capability that is available when the sensing signal is transmitted, for example, a sensing capability for a power, a subcarrier, a bandwidth, and the like of the sensing signal that can be transmitted by the device.

The sensing action may include receiving a sensing signal, and the sensing capability information associated with receiving a sensing signal may be used to indicate a corresponding sensing capability that is available when the sensing signal is received, for example, a sensing capability for a subcarrier, a bandwidth, a beam, and the like of the sensing signal that can be received by the device.

The sensing action may include transmitting or receiving a sensing signal, and the sensing capability information associated with transmitting or receiving a sensing signal may be used to indicate a corresponding sensing capability that the device has when transmitting a sensing signal or receiving a sensing signal.

The sensing action may include transmitting and receiving sensing signals at the same time, and the sensing capability information associated with transmitting and receiving sensing signals at the same time may be used to indicate that the device has a corresponding sensing capability to transmit and receive sensing signals at the same time (that is, a sensing echo signal can be received while a sensing signal is transmitted).

The sensing action may include processing a sensing signal, and the sensing capability information associated with processing a sensing signal may be used to indicate that the device has a capability of performing sensing signal processing on a corresponding sensing signal.

Optionally, the sending, by a first communication device, device capability information of the first communication device to a second communication device includes:
sending, by the first communication device, a target container to the second communication device.

The target container carries a second information element, the second information element is used to indicate device capability information, associated with the second identifier, of the first communication device, and the target container corresponds to at least one of the first identifier and the second identifier.

The target container may be in a one-to-one correspondence with the first identifier. Alternatively, the target container may be in a one-to-one correspondence with the second identifier.

In an implementation, the second information element may be an information element corresponding to a band (that is, per band), or the second information element may be an information element corresponding to a component carrier (that is, per CC).

For example, the second communication device may include, in a first request sent to the first communication device, a first identifier and/or a second identifier (the first identifier and/or the second identifier is used as a filter) that is used to indicate a specific part of capability information of the first communication device that needs to be reported by the first communication device. Correspondingly, the first communication device packages the part of the capability information of the first communication device specified by the first identifier and/or the second identifier (that is, the filter) into a corresponding target container (that is, a container), and sends the capability information to the second communication device by using capability information reporting signaling. Clearly, the first identifier and/or the second identifier (that is, the filter) and the target container (that is, the container) are in a one-to-one correspondence. In an existing protocol, the filter and the container of the capability of the first communication device in a communication system mainly include two aspects: band and RAT. In other words, the second communication device may specify device capabilities related to specific bands and RATs (which are mainly E-UTRA or NR) to be reported by the first communication device.

Optionally, in a case that a second request sent by the second communication device is received, if an object indicated by a second identifier in the second request and the object indicated by the second identifier in the first request satisfy a fallback relationship, the first communication device does not need to send, to the second communication device, device capability information associated with the second identifier in the second request.

It should be noted that if an object indicated by a second identifier in the second request and the object indicated by the second identifier in the first request satisfy a fallback relationship, the first communication device does not need to send, to the second communication device, device capability information associated with the second identifier in the second request. In this way, there is a fallback mechanism for exchange of the sensing capability information of the device. To be specific, low-configuration sensing capability information does not need to be reported after high-configuration sensing capability information is reported. For example, if ten consecutive CCs support a specific capability, any five consecutive CCs in the ten CCs certainly also support the capability, and no repeated reporting is required.

The fallback mechanism is introduced into the mechanism of exchanging the sensing capability information, so that after reporting higher-configuration sensing capability information, the device does not need to repeatedly report lower-configuration sensing capability information, thereby reducing overheads for exchanging the sensing capability information of the device.

Optionally, the object indicated by the second identifier in the second request and the object indicated by the second identifier in the first request satisfying a fallback relationship includes at least one of the following:
a band of integrated sensing and communication indicated by the second identifier in the second request is a subset of a band of integrated sensing and communication indicated by the second identifier in the first request;
a RAT of integrated sensing and communication indicated by the second identifier in the second request is a subset of a RAT of integrated sensing and communication indicated by the second identifier in the first request;
a sensing action indicated by the second identifier in the second request is a subset of a sensing action indicated by the second identifier in the first request;
the sensing action indicated by the second identifier in the first request is transmitting and receiving sensing signals at the same time, and the sensing action indicated by the second identifier in the second request is at least one of transmitting a sensing signal, receiving a sensing signal, and transmitting or receiving a sensing signal; and
the sensing action indicated by the second identifier in the first request is transmitting or receiving a sensing signal, and the sensing action indicated by the second identifier in the second request is at least one of transmitting a sensing signal and receiving a sensing signal.

In an implementation, for the first request, if the first communication device has reported the sensing capability information that supports M CCs or bands or band combinations, the first communication device does not need to repeatedly report the sensing capability information of N<M CCs or bands or band combinations.

In an implementation, for the first request, if the first communication device has reported the sensing capability information of the multi-RAT, the first communication device does not need to report the sensing capability information of any RAT in the multi-RAT.

In an implementation, for the first request, if the first communication device has reported the sensing capability information related to “transmitting or receiving a sensing signal” or “transmitting and receiving sensing signals at the same time”, the first communication device does not need to report the sensing capability information related to “transmitting a sensing signal” or “receiving a sensing signal”.

Referring to FIG. 7, FIG. 7 is a flowchart of an information receiving method according to an embodiment of this application. As shown in FIG. 7, the information receiving method includes the following step:

Step 201: A second communication device receives device capability information of a first communication device that is sent by the first communication device.

The device capability information of the first communication device includes at least one piece of the following sensing capability information:
indication information used to indicate whether sensing is supported;
sensing mobility management capability information;
sensing reporting capability information;
sensing information processing capability information;
sensing signal support capability information;
sensing link adaptation capability information; and
sensing assistance support capability information.

Optionally, before the receiving, by a second communication device, device capability information of a first communication device that is sent by the first communication device, the method further includes:
sending, by the second communication device, a first request to the first communication device, where the first request includes a first identifier, and the first identifier includes at least one of the following: a communication capability identifier; and a sensing capability identifier.

The communication capability identifier is used to indicate to report communication capability information, and the sensing capability identifier is used to indicate to report sensing capability information.

Optionally, in a case that the first identifier includes a sensing capability identifier, the first request further includes a second identifier, where the second identifier is used to indicate to report sensing capability information associated with at least one of the following objects: a sensing action; a service type of integrated sensing and communication; a RAT of integrated sensing and communication; and a band of integrated sensing and communication.

Optionally, the receiving, by a second communication device, device capability information of a first communication device that is sent by the first communication device includes: receiving, by the second communication device, a target container sent by the first communication device.

The target container carries a second information element, the second information element is used to indicate device capability information, associated with the second identifier, of the first communication device, and the target container corresponds to at least one of the first identifier and the second identifier.

Optionally, the second communication device does not send a third request to the first communication device, where the third request includes a second identifier, and an object indicated by the second identifier in the third request and the object indicated by the second identifier in the first request satisfy a fallback relationship.

Optionally, the object indicated by the second identifier in the third request and the object indicated by the second identifier in the first request satisfying a fallback relationship includes at least one of the following:
a band of integrated sensing and communication indicated by the second identifier in the third request is a subset of a band of integrated sensing and communication indicated by the second identifier in the first request;
a RAT of integrated sensing and communication indicated by the second identifier in the third request is a subset of a RAT of integrated sensing and communication indicated by the second identifier in the first request;
a sensing action indicated by the second identifier in the third request is a subset of a sensing action indicated by the second identifier in the first request;
the sensing action indicated by the second identifier in the first request is transmitting and receiving sensing signals at the same time, and the sensing action indicated by the second identifier in the third request is at least one of transmitting a sensing signal, receiving a sensing signal, and transmitting or receiving a sensing signal; and
the sensing action indicated by the second identifier in the first request is transmitting or receiving a sensing signal, and the sensing action indicated by the second identifier in the third request is at least one of transmitting a sensing signal and receiving a sensing signal.

Optionally, after the receiving, by a second communication device, device capability information of a first communication device that is sent by the first communication device, the method further includes:
receiving, by the second communication device, a fourth request sent by a third communication device, where the fourth request is used to request the second communication device to send the device capability information of the first communication device; and
sending, by the second communication device to the third communication device, the device capability information of the first communication device corresponding to the fourth request.

Optionally, the fourth request carries at least one of the following:
a device identifier of the first communication device;
a first identifier, where the first identifier includes at least one of the following: a communication capability identifier; and a sensing capability identifier, where the communication capability identifier is used to indicate to report communication capability information, and the sensing capability identifier is used to indicate to report sensing capability information; and
a second identifier, where the second identifier is used to indicate to report sensing capability information associated with at least one of the following objects: a sensing action; a service type of integrated sensing and communication; a RAT of integrated sensing and communication; and a band of integrated sensing and communication.

Optionally, the sensing action includes at least one of the following:
transmitting a sensing signal;
receiving a sensing signal;
transmitting or receiving a sensing signal;
transmitting and receiving sensing signals at the same time; and
processing a sensing signal.

It should be noted that this embodiment is used as an implementation corresponding to the second communication device in the embodiment shown in FIG. 6. For a specific implementation of this embodiment, refer to related descriptions of the embodiment shown in FIG. 6. To avoid repetition, details are not described in this embodiment.

Referring to FIG. 8, FIG. 8 is a flowchart of an information receiving method according to an embodiment of this application. As shown in FIG. 8, the information receiving method includes the following step:

Step 301: A third communication device receives device capability information of a first communication device that is sent by a second communication device.

The device capability information of the first communication device includes at least one piece of the following sensing capability information:
indication information used to indicate whether sensing is supported;
sensing mobility management capability information;
sensing reporting capability information;
sensing information processing capability information;
sensing signal support capability information;
sensing link adaptation capability information; and
sensing assistance support capability information.

Optionally, before the receiving, by a third communication device, device capability information of a first communication device that is sent by a second communication device, the method further includes:
sending, by the third communication device, a fourth request to the second communication device, where the fourth request is used to request the second communication device to send the device capability information of the first communication device.

Optionally, the fourth request carries at least one of the following:
a device identifier of the first communication device;
a first identifier, where the first identifier includes at least one of the following: a communication capability identifier; and a sensing capability identifier, where the communication capability identifier is used to indicate to report communication capability information, and the sensing capability identifier is used to indicate to report sensing capability information; and
a second identifier, where the second identifier is used to indicate to report sensing capability information associated with at least one of the following objects: a sensing action; a service type of integrated sensing and communication; a RAT of integrated sensing and communication; and a band of integrated sensing and communication.

It should be noted that this embodiment is used as an implementation corresponding to the third communication device in the embodiment shown in FIG. 6 and FIG. 7. For a specific implementation of this embodiment, refer to related descriptions of the embodiment shown in FIG. 6 and FIG. 7. To avoid repetition, details are not described in this embodiment.

The following describes, by using several specific embodiments, the information sending method and the information receiving method that are provided in the embodiments of this application.

### Embodiment 1

Similar to signaling exchange for the UE capability in a communication system, in a system of integrated sensing and communication, only a part rather than all of sensing capability information of a device usually needs to be reported, which is referred to herein as filtering of the sensing capability information. The filtering of the sensing capability information can greatly reduce overheads for exchanging the sensing capability information.

### 1. Filter and Container of Communication Capability and Sensing Capability

In the system of integrated sensing and communication, the device capability information includes two categories: communication capability information and sensing capability information. The communication capability information includes UE capability information in an existing NR protocol, and the sensing capability information is capability information required for executing a sensing service. It is easy to understand that there may be some identical capability information in the sensing capability information and the communication capability information.

During exchange of the device capability information, the communication capability information may be separately reported, or the sensing capability information may be separately reported. Therefore, a filter and a corresponding container for the exchange of the device capability information may include:

1. A filter for reporting the communication capability information and/or the sensing capability information includes at least one of the following:
reporting the communication capability information: instructing the device to report the communication capability information; filtering of specific communication capability information may be performed according to a UE capability filtering method in the existing protocol;
reporting the sensing capability information: instructing the device to report the sensing capability information; specific sensing capability information may be further filtered according to the methods in the following filter and container of the sensing capability information, so as to reduce overheads; and
reporting the communication capability information and the sensing capability information: instructing the device to report the communication capability information and the sensing capability information; a method for filtering specific communication capability information and sensing capability information is the same as the foregoing methods for reporting the communication capability information and reporting the sensing capability information.

Herein, the device may refer to a base station or UE.

### 2. Filter and Container of Sensing Capability Information

In the communication system, the capability information query signaling UECapabilityEnquiry signaling sent by the base station to the UE includes a filter that is used to indicate a specific part of a UE capability that needs to be reported by the UE. Correspondingly, the UE packages the part of UE capability information specified by the filter into a corresponding container, and sends the UE capability information to the base station by using the capability information reporting signaling UECapability Information signaling. Clearly, the filter and the container are in a one-to-one correspondence. In the communication system, the filter and the container of the UE capability mainly include two aspects: band and RAT. In other words, the base station may specify UE capabilities related to specific bands and RATs (which are mainly E-UTRA or NR) to be reported by the UE.

In the system of integrated sensing and communication, the filter and the container of sensing capability information may include the following dimensions:

(1) Sensing action (transmitting, receiving, and processing of the sensing signal), where the sensing action includes at least one of the following:
transmitting a sensing signal, receiving a sensing signal, transmitting or receiving a sensing signal, transmitting and receiving sensing signals at the same time, and processing a sensing signal.

For example, if the filter includes only “transmitting a sensing signal”, the device needs to report only a subset of sensing capability information related to transmitting a sensing signal.

(2) Service type of integrated sensing and communication.

(3) RAT of integrated sensing and communication.

(4) Band of integrated sensing and communication, where the band of integrated sensing and communication may be a band that supports communication and sensing.

In this embodiment, the device capability information can be filtered.

### Embodiment 2

In a related technology, reporting of the UE capability includes two optional processes. One process is that capability information is reported during UE registration and stored in a network, and the network pushes the UE capability information to a base station that needs the UE capability information. The other process is that the base station queries UE capability information by using signaling, and the UE reports capability information according to a requirement of the query signaling.

In integrated sensing and communication, the process of exchanging the device capability information (including the communication capability information and the sensing capability information) may be extended according to the process of reporting the UE capability in the related technology. It should be emphasized that the device described in this embodiment may be a base station or UE. Therefore, the process of exchanging the device capability information (including the communication capability information and the sensing capability information) may include at least one of registration-based reporting and query-based reporting.

### 1. Registration-Based Reporting

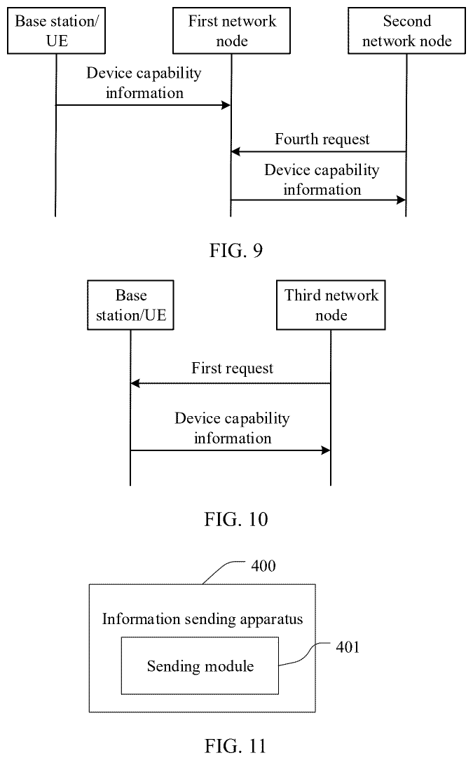

As shown in FIG. 9, the registration-based reporting mainly includes the following steps:

(1) The device (which corresponds to the foregoing first communication device, and may be a base station or UE) reports device capability information (including communication capability information and sensing capability information) of the device to a network in a registration process of accessing the network, and the device capability information is stored in a first network node (corresponding to the foregoing second communication device).

(2) When a second network node (corresponding to the foregoing third communication device) needs to use the device capability information, the second network node sends a fourth request to the first network node, so as to instruct the first network node to send the device capability information to the second network node.

The “fourth request” includes at least the following content:
a device ID or a device ID list; and
a filter (for example, the filter described in Embodiment 1) of the capability information.

In an implementation, the second network node may be a sensing function network element (refer to explanation 3: sensing function network element).

(3) The first network node sends the specified part of capability information (determined based on the filter of the capability information) of the specified device (determined based on the device ID) to the second network node according to a requirement in the “fourth request”.

### 2. Query-Based Reporting

As shown in FIG. 10, the basic process of exchanging the device capability information (including the communication capability information and the sensing capability information) is as follows:

(1) The third network node (corresponding to the foregoing second communication device) sends a first request to the device (corresponding to the foregoing first communication device), requesting the device to report the device capability information. The device may be a base station or may be UE.

If the device is UE, the “first request” may be UECapabilityEnquiry signaling, and the third network node may be a base station.

If the device is a base station, the “first request” may be newly defined signaling, and the third network node may be a sensing function network element (refer to explanation 3: sensing function network element).

The “first request” includes a filter (for example, the filter described in Embodiment 1) of the device capability information, so as to indicate which device capability information the device needs to report. For example, if the filter in the “first request” includes “sensing capability information” and “receiving a sensing signal”, the device needs to report, to the third network node, the capability information of the device about receiving a sensing signal.

(2) The device packages the corresponding device capability information into a corresponding container based on the filter in the “first request”, and sends the corresponding device capability information to the network by using the “device capability information” signaling, including:

If the device is UE, the “device capability information” signaling may be UECapability Information signaling.

If the device is a base station, the “device capability information” signaling may be newly defined signaling.

In this embodiment, the device capability information can be exchanged.

The information sending method provided in the embodiments of this application may be performed by an information sending apparatus. In the embodiments of this application, the information sending apparatus provided in the embodiments of this application is described by using an example in which the information sending apparatus performs the information sending method.

Referring to FIG. 11, FIG. 11 is a structural diagram of an information sending apparatus according to an embodiment of this application. A first communication device includes the information sending apparatus. As shown in FIG. 11, the information sending apparatus 400 includes:
a sending module 401, configured to send device capability information of the first communication device to a second communication device, where
the device capability information of the first communication device includes at least one piece of the following sensing capability information:
indication information used to indicate whether sensing is supported;
sensing mobility management capability information;
sensing reporting capability information;
sensing information processing capability information;
sensing signal support capability information;
sensing link adaptation capability information; and
sensing assistance support capability information.

Optionally, the device capability information of the first communication device is carried in a first information element, and the first information element is used to indicate at least one of communication capability information and sensing capability information.

Optionally, the sensing mobility management capability information is used to indicate at least one of the following:
whether sensing mobility management is supported;
a measurement quantity supported by the sensing mobility management;
a measurement object supported by the sensing mobility management; and
a measurement event supported by the sensing mobility management.

Optionally, the measurement quantity supported by the sensing mobility management includes at least one of the following: a measurement quantity related to communication mobility management; a sensing measurement quantity; a sensing signal power; a sensing signal to interference plus noise ratio SINR; a sensing signal to noise ratio SNR; and an operation result of a target operation performed by using a target measurement quantity.

Optionally, the sensing reporting capability information is used to indicate one of the following:
whether a physical uplink control channel PUCCH reporting a sensing measurement quantity is supported;
whether the PUCCH reporting a sensing result is supported;
whether a physical uplink shared channel PUSCH reporting a sensing measurement quantity is supported;
whether the PUSCH reporting a sensing result is supported; and
a supported reporting manner of the sensing measurement quantity or the sensing result, where the reporting manner includes at least one of periodic reporting, semi-persistent reporting, and aperiodic reporting.

Optionally, the sensing information processing capability information is used to indicate at least one of the following:
a supported sensing signal processing type;
a sensing data processing capability;
whether conversion from the sensing measurement quantity to the sensing result is supported;
a coherent processing time supported by performing sensing signal processing;
a data computing capability of a sensing service;
a data storage capability of the sensing service;
whether a sensing requirement processing capability is available; and
whether a sensing result fusion capability is available.

Optionally, the supported sensing signal processing type includes a supported sensing signal processing algorithm, and the supported sensing signal processing algorithm includes at least one of the following: Fourier transform; a spectral analysis operation of a non-uniform sequence; a high resolution algorithm; a constant false alarm detection algorithm; and an artificial intelligence AI pattern recognition algorithm;
or
the sensing data processing capability includes at least one of the following: whether motion compensation is supported; whether a sensing object trajectory management capability is available; and a supported multi-target sensing capability.

Optionally, the sensing signal support capability information is used to indicate at least one of the following:
a sensing signal transceiving capability;
a sensing beam support capability;
a multi-node collaboration sensing capability;
a multiple input multiple output MIMO sensing capability; and
a multi-radio access technology multi-RAT sensing capability.

Optionally, the sensing signal transceiving capability includes at least one of the following: whether receiving a sensing signal is supported; whether transmitting a sensing signal is supported; whether receiving and transmitting a sensing signal is supported; and whether receiving and transmitting sensing signals at the same time are supported;
or
the sensing beam support capability includes at least one of the following: a supported beam saltus; and a supported beam quantity;
or
the multi-node collaboration sensing capability includes at least one of the following: a maximum quantity of ports for transmitting a sensing signal; and a maximum quantity of ports for receiving a sensing signal;
or
the MIMO sensing capability includes at least one of the following: whether MIMO sensing is supported; a supported maximum quantity of related antenna ports; a supported antenna arrangement; whether switching between MIMO sensing and non-MIMO sensing is supported; and a supported MIMO sensing manner;
or
the multi-RAT sensing capability includes at least one of the following: a radio access technology RAT type that supports a sensing service; and whether multi-RAT collaboration sensing is supported.

Optionally, the sensing assistance support capability information is used to indicate at least one of the following:
whether obtaining device state information is supported;
whether execution of a sensing service is allowed; and
a capability of an equipped sensor.

Optionally, the apparatus further includes:
a receiving module, configured to receive a first request sent by the second communication device, where the first request includes a first identifier, and the first identifier includes at least one of the following: a communication capability identifier; and a sensing capability identifier;
the communication capability identifier is used to indicate to report communication capability information, and the sensing capability identifier is used to indicate to report sensing capability information.

Optionally, in a case that the first identifier includes a sensing capability identifier, the first request further includes a second identifier, where the second identifier is used to indicate to report sensing capability information associated with at least one of the following objects: a sensing action; a service type of integrated sensing and communication; a RAT of integrated sensing and communication; and a band of integrated sensing and communication.

Optionally, the sensing action includes at least one of the following:
transmitting a sensing signal;
receiving a sensing signal;
transmitting or receiving a sensing signal;
transmitting and receiving sensing signals at the same time; and
processing a sensing signal.

Optionally, the sending module is specifically configured to:
send a target container to the second communication device, where
the target container carries a second information element, the second information element is used to indicate device capability information, associated with the second identifier, of the first communication device, and the target container corresponds to at least one of the first identifier and the second identifier.

Optionally, in a case that a second request sent by the second communication device is received, if an object indicated by a second identifier in the second request and the object indicated by the second identifier in the first request satisfy a fallback relationship, the first communication device does not need to send, to the second communication device, device capability information associated with the second identifier in the second request.

Optionally, the object indicated by the second identifier in the second request and the object indicated by the second identifier in the first request satisfying a fallback relationship includes at least one of the following:
a band of integrated sensing and communication indicated by the second identifier in the second request is a subset of a band of integrated sensing and communication indicated by the second identifier in the first request;
a RAT of integrated sensing and communication indicated by the second identifier in the second request is a subset of a RAT of integrated sensing and communication indicated by the second identifier in the first request;
a sensing action indicated by the second identifier in the second request is a subset of a sensing action indicated by the second identifier in the first request;
the sensing action indicated by the second identifier in the first request is transmitting and receiving sensing signals at the same time, and the sensing action indicated by the second identifier in the second request is at least one of transmitting a sensing signal, receiving a sensing signal, and transmitting or receiving a sensing signal; and
the sensing action indicated by the second identifier in the first request is transmitting or receiving a sensing signal, and the sensing action indicated by the second identifier in the second request is at least one of transmitting a sensing signal and receiving a sensing signal.

In the embodiments of this application, the first communication device reports sensing-related capability information to the second communication device, so that exchange of a device capability extends to exchange of a sensing capability. This avoids an undiversified type of a capability exchanged between devices, thereby improving performance of exchange between devices, and improving sensing performance through sensing capability exchange.

The information sending apparatus in the embodiments of this application may be an electronic device, for example, an electronic device with an operating system, or may be a component such as an integrated circuit or a chip in an electronic device. The electronic device may be a terminal, or may be another device different from a terminal. For example, the terminal may include but is not limited to the foregoing listed types of the terminal 11. The another device may be a server, a network attached storage (NAS), or the like. This is not specifically limited in the embodiments of this application.

The information sending apparatus provided in the embodiments of this application can implement processes implemented in the method embodiment in FIG. 6, and achieve same technical effects. To avoid repetition, details are not described herein again.

The information receiving method provided in the embodiments of this application may be performed by an information receiving apparatus. In the embodiments of this application, the information receiving apparatus provided in the embodiments of this application is described by using an example in which the information receiving apparatus performs the information receiving method.

Referring to FIG. 12, FIG. 12 is a structural diagram of an information receiving apparatus according to an embodiment of this application. A second communication device includes the information receiving apparatus. As shown in FIG. 12, the information receiving apparatus 500 includes:
a first receiving module 501, configured to receive device capability information of a first communication device that is sent by the first communication device, where
the device capability information of the first communication device includes at least one piece of the following sensing capability information:
indication information used to indicate whether sensing is supported;
sensing mobility management capability information;
sensing reporting capability information;
sensing information processing capability information;
sensing signal support capability information;
sensing link adaptation capability information; and
sensing assistance support capability information.

Optionally, the apparatus further includes:
a first sending module, configured to send a first request to the first communication device, where the first request includes a first identifier, and the first identifier includes at least one of the following: a communication capability identifier; and a sensing capability identifier;
the communication capability identifier is used to indicate to report communication capability information, and the sensing capability identifier is used to indicate to report sensing capability information.

Optionally, in a case that the first identifier includes a sensing capability identifier, the first request further includes a second identifier, where the second identifier is used to indicate to report sensing capability information associated with at least one of the following objects: a sensing action; a service type of integrated sensing and communication; a RAT of integrated sensing and communication; and a band of integrated sensing and communication.

Optionally, the first receiving module is specifically configured to:
receive a target container sent by the first communication device, where
the target container carries a second information element, the second information element is used to indicate device capability information, associated with the second identifier, of the first communication device, and the target container corresponds to at least one of the first identifier and the second identifier.

Optionally, the second communication device does not send a third request to the first communication device, where the third request includes a second identifier, and an object indicated by the second identifier in the third request and the object indicated by the second identifier in the first request satisfy a fallback relationship.

Optionally, the object indicated by the second identifier in the third request and the object indicated by the second identifier in the first request satisfying a fallback relationship includes at least one of the following:
a band of integrated sensing and communication indicated by the second identifier in the third request is a subset of a band of integrated sensing and communication indicated by the second identifier in the first request;
a RAT of integrated sensing and communication indicated by the second identifier in the third request is a subset of a RAT of integrated sensing and communication indicated by the second identifier in the first request;
a sensing action indicated by the second identifier in the third request is a subset of a sensing action indicated by the second identifier in the first request;
the sensing action indicated by the second identifier in the first request is transmitting and receiving sensing signals at the same time, and the sensing action indicated by the second identifier in the third request is at least one of transmitting a sensing signal, receiving a sensing signal, and transmitting or receiving a sensing signal; and
the sensing action indicated by the second identifier in the first request is transmitting or receiving a sensing signal, and the sensing action indicated by the second identifier in the third request is at least one of transmitting a sensing signal and receiving a sensing signal.

Optionally, the apparatus further includes:
a second receiving module, configured to receive a fourth request sent by a third communication device, where the fourth request is used to request the second communication device to send the device capability information of the first communication device; and
a second sending module, configured to send, to the third communication device, the device capability information of the first communication device corresponding to the fourth request.

Optionally, the fourth request carries at least one of the following:
a device identifier of the first communication device;
a first identifier, where the first identifier includes at least one of the following: a communication capability identifier; and a sensing capability identifier, where the communication capability identifier is used to indicate to report communication capability information, and the sensing capability identifier is used to indicate to report sensing capability information; and
a second identifier, where the second identifier is used to indicate to report sensing capability information associated with at least one of the following objects: a sensing action; a service type of integrated sensing and communication; a RAT of integrated sensing and communication; and a band of integrated sensing and communication.

Optionally, the sensing action includes at least one of the following:
transmitting a sensing signal;
receiving a sensing signal;
transmitting or receiving a sensing signal;
transmitting and receiving sensing signals at the same time; and
processing a sensing signal.

The information receiving apparatus in the embodiments of this application may be an electronic device, for example, an electronic device with an operating system, or may be a component such as an integrated circuit or a chip in an electronic device. The electronic device may be a terminal, or may be another device different from a terminal. For example, the terminal may include but is not limited to the foregoing listed types of the terminal 11. The another device may be a server, a network attached storage (NAS), or the like. This is not specifically limited in the embodiments of this application.

The information receiving apparatus provided in the embodiments of this application can implement processes implemented in the method embodiment in FIG. 7, and achieve same technical effects. To avoid repetition, details are not described herein again.

The information receiving method provided in the embodiments of this application may be performed by an information receiving apparatus. In the embodiments of this application, the information receiving apparatus provided in the embodiments of this application is described by using an example in which the information receiving apparatus performs the information receiving method.

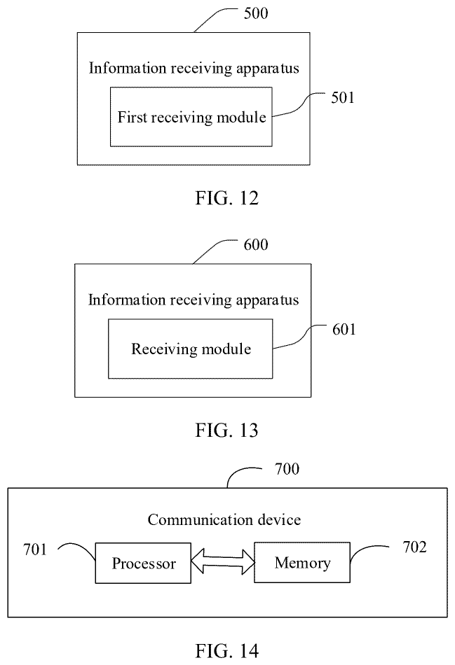

Referring to FIG. 13, FIG. 13 is a structural diagram of an information receiving apparatus according to an embodiment of this application. A third communication device includes the information receiving apparatus. As shown in FIG. 13, the information receiving apparatus 600 includes:
a receiving module 601, configured to receive device capability information of a first communication device that is sent by a second communication device, where
the device capability information of the first communication device includes at least one piece of the following sensing capability information:
indication information used to indicate whether sensing is supported;
sensing mobility management capability information;
sensing reporting capability information;
sensing information processing capability information;
sensing signal support capability information;
sensing link adaptation capability information; and
sensing assistance support capability information.

Optionally, the apparatus further includes:
a sending module, configured to send a fourth request to the second communication device, where the fourth request is used to request the second communication device to send the device capability information of the first communication device.

Optionally, the fourth request carries at least one of the following:
a device identifier of the first communication device;
a first identifier, where the first identifier includes at least one of the following: a communication capability identifier; and a sensing capability identifier, where the communication capability identifier is used to indicate to report communication capability information, and the sensing capability identifier is used to indicate to report sensing capability information; and
a second identifier, where the second identifier is used to indicate to report sensing capability information associated with at least one of the following objects: a sensing action; a service type of integrated sensing and communication; a RAT of integrated sensing and communication; and a band of integrated sensing and communication.

The information receiving apparatus in the embodiments of this application may be an electronic device, for example, an electronic device with an operating system, or may be a component such as an integrated circuit or a chip in an electronic device. The electronic device may be a terminal, or may be another device different from a terminal. For example, the terminal may include but is not limited to the foregoing listed types of the terminal 11. The another device may be a server, a network attached storage (NAS), or the like. This is not specifically limited in the embodiments of this application.

The information receiving apparatus provided in the embodiments of this application can implement processes implemented in the method embodiment in FIG. 8, and achieve same technical effects. To avoid repetition, details are not described herein again.

Optionally, as shown in FIG. 14, an embodiment of this application further provides a communication device 700, including a processor 701 and a memory 702. The memory 702 stores a program or instructions capable of running on the processor 701. For example, when the communication device 700 is a first communication device, the program or the instructions are executed by the processor 701 to implement the steps of the foregoing information sending method embodiments applicable to the first communication device, and the same technical effects can be achieved. To avoid repetition, details are not described herein again. When the communication device 700 is a second communication device, the program or the instructions are executed by the processor 701 to implement the steps of the foregoing information receiving method embodiments applicable to the second communication device, and the same technical effects can be achieved. To avoid repetition, details are not described herein again. When the communication device 700 is a third communication device, the program or the instructions are executed by the processor 701 to implement the steps of the foregoing information receiving method embodiments applicable to the third communication device, and the same technical effects can be achieved. To avoid repetition, details are not described herein again.

An embodiment of this application further provides a communication device, including a processor and a communication interface, where the communication interface is configured to send device capability information of a first communication device to a second communication device, where the device capability information of the first communication device includes at least one piece of the following sensing capability information: indication information used to indicate whether sensing is supported; sensing mobility management capability information; sensing reporting capability information; sensing information processing capability information; sensing signal support capability information; sensing link adaptation capability information; and sensing assistance support capability information.

An embodiment of this application further provides a communication device, including a processor and a communication interface, where the communication interface is configured to receive device capability information of a first communication device that is sent by the first communication device, where the device capability information of the first communication device includes at least one piece of the following sensing capability information: indication information used to indicate whether sensing is supported; sensing mobility management capability information; sensing reporting capability information; sensing information processing capability information; sensing signal support capability information; sensing link adaptation capability information; and sensing assistance support capability information.

An embodiment of this application further provides a communication device, including a processor and a communication interface, where the communication interface is configured to receive device capability information of a first communication device that is sent by a second communication device, where the device capability information of the first communication device includes at least one piece of the following sensing capability information: indication information used to indicate whether sensing is supported; sensing mobility management capability information; sensing reporting capability information; sensing information processing capability information; sensing signal support capability information; sensing link adaptation capability information; and sensing assistance support capability information.

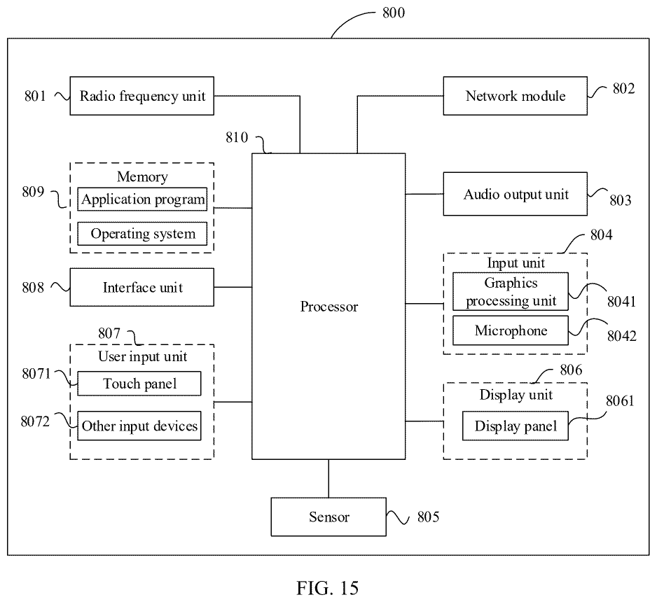

Optionally, the communication device (for example, the first communication device, the second communication device, or the third communication device) may be a terminal. Specifically, FIG. 15 is a schematic diagram of a hardware structure of a terminal for implementing an embodiment of this application.

The terminal 800 includes but is not limited to at least some components in a radio frequency unit 801, a network module 802, an audio output unit 803, an input unit 804, a sensor 805, a display unit 806, a user input unit 807, an interface unit 808, a memory 809, a processor 810, and the like.

A person skilled in the art may understand that the terminal 800 may further include a power supply (for example, a battery) that supplies power to each component. The power supply may be logically connected to the processor 810 by using a power management system, so as to implement functions such as charging management, discharging management, and power consumption management by using the power management system. The structure of the terminal shown in FIG. 15 does not constitute a limitation on the terminal. The terminal may include more or fewer components than those shown in the figure, or combine some components, or have different component arrangements. Details are not described herein again.

It should be understood that in the embodiments of this application, the input unit 804 may include a graphics processing unit (GPU) 8041 and a microphone 8042. The graphics processing unit 8041 processes image data of a still picture or a video obtained by an image capture apparatus (such as a camera) in a video capture mode or an image capture mode. The display unit 806 may include a display panel 8081, and the display panel 8081 may be configured in a form of a liquid crystal display, an organic light-emitting diode, or the like. The user input unit 807 includes at least one of a touch panel 8071 and other input devices 8072. The touch panel 8071 is also referred to as a touchscreen. The touch panel 8071 may include two parts: a touch detection apparatus and a touch controller. The other input devices 8072 may include but are not limited to a physical keyboard, a function key (such as a volume control key or an on/off key), a trackball, a mouse, and a joystick. Details are not described herein.

In the embodiments of this application, after receiving downlink data from a network side device, the radio frequency unit 801 may transmit the downlink data to the processor 810 for processing. In addition, the radio frequency unit 801 may send uplink data to the network side device. Generally, the radio frequency unit 801 includes but is not limited to an antenna, an amplifier, a transceiver, a coupler, a low-noise amplifier, a duplexer, and the like.

The memory 809 may be configured to store a software program or instructions and various types of data. The memory 809 may mainly include a first storage area for storing a program or instructions and a second storage area for storing data. The first storage area may store an operating system, an application program or instructions required by at least one function (for example, a sound playing function or an image playing function), and the like. In addition, the memory 809 may include a volatile memory or a nonvolatile memory, or the memory 809 may include both a volatile memory and a nonvolatile memory. The nonvolatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchlink dynamic random access memory (Synch link DRAM, SLDRAM), and a direct rambus random access memory (Direct Rambus RAM, DRRAM). The memory 909 in the embodiments of this application includes but is not limited to these memories and any other suitable type of memory.

The processor 810 may include one or more processing units. Optionally, the processor 810 is integrated with an application processor and a modem processor. The application processor mainly processes operations related to an operating system, a user interface, an application program, and the like. The modem processor mainly processes a wireless communication signal, such as a baseband processor. It may be understood that, the foregoing modem processor may not be integrated into the processor 810.

In a case that the terminal is a first communication device,
the radio frequency unit 801 is configured to send device capability information of the first communication device to a second communication device, where
the device capability information of the first communication device includes at least one piece of the following sensing capability information:
indication information used to indicate whether sensing is supported;
sensing mobility management capability information;
sensing reporting capability information;
sensing information processing capability information;
sensing signal support capability information;
sensing link adaptation capability information; and
sensing assistance support capability information.

Optionally, the device capability information of the first communication device is carried in a first information element, and the first information element is used to indicate at least one of communication capability information and sensing capability information.

Optionally, the sensing mobility management capability information is used to indicate at least one of the following:
whether sensing mobility management is supported;
a measurement quantity supported by the sensing mobility management;
a measurement object supported by the sensing mobility management; and
a measurement event supported by the sensing mobility management.

Optionally, the measurement quantity supported by the sensing mobility management includes at least one of the following: a measurement quantity related to communication mobility management; a sensing measurement quantity; a sensing signal power; a sensing signal to interference plus noise ratio SINR; a sensing signal to noise ratio SNR; and an operation result of a target operation performed by using a target measurement quantity.

Optionally, the sensing reporting capability information is used to indicate one of the following:
whether a physical uplink control channel PUCCH reporting a sensing measurement quantity is supported;
whether the PUCCH reporting a sensing result is supported;
whether a physical uplink shared channel PUSCH reporting a sensing measurement quantity is supported;
whether the PUSCH reporting a sensing result is supported; and
a supported reporting manner of the sensing measurement quantity or the sensing result, where the reporting manner includes at least one of periodic reporting, semi-persistent reporting, and aperiodic reporting.

Optionally, the sensing information processing capability information is used to indicate at least one of the following:
a supported sensing signal processing type;
a sensing data processing capability;
whether conversion from the sensing measurement quantity to the sensing result is supported;
a coherent processing time supported by performing sensing signal processing;
a data computing capability of a sensing service;
a data storage capability of the sensing service;
whether a sensing requirement processing capability is available; and
whether a sensing result fusion capability is available.

Optionally, the supported sensing signal processing type includes a supported sensing signal processing algorithm, and the supported sensing signal processing algorithm includes at least one of the following: Fourier transform; a spectral analysis operation of a non-uniform sequence; a high resolution algorithm; a constant false alarm detection algorithm; and an artificial intelligence AI pattern recognition algorithm;
or
the sensing data processing capability includes at least one of the following: whether motion compensation is supported; whether a sensing object trajectory management capability is available; and a supported multi-target sensing capability.

Optionally, the sensing signal support capability information is used to indicate at least one of the following:
a sensing signal transceiving capability;
a sensing beam support capability;
a multi-node collaboration sensing capability;
a multiple input multiple output MIMO sensing capability; and
a multi-radio access technology multi-RAT sensing capability.

Optionally, the sensing signal transceiving capability includes at least one of the following: whether receiving a sensing signal is supported; whether transmitting a sensing signal is supported; whether receiving and transmitting a sensing signal is supported; and whether receiving and transmitting sensing signals at the same time are supported;
or
the sensing beam support capability includes at least one of the following: a supported beam saltus; and a supported beam quantity;
or
the multi-node collaboration sensing capability includes at least one of the following:
a maximum quantity of ports for transmitting a sensing signal; and a maximum quantity of ports for receiving a sensing signal;
or
the MIMO sensing capability includes at least one of the following: whether MIMO sensing is supported; a supported maximum quantity of related antenna ports; a supported antenna arrangement; whether switching between MIMO sensing and non-MIMO sensing is supported; and a supported MIMO sensing manner;
or
the multi-RAT sensing capability includes at least one of the following: a radio access technology RAT type that supports a sensing service; and whether multi-RAT collaboration sensing is supported.

Optionally, the sensing assistance support capability information is used to indicate at least one of the following:
whether obtaining device state information is supported;
whether execution of a sensing service is allowed; and
a capability of an equipped sensor.

Optionally, the radio frequency unit 801 is further configured to receive a first request sent by the second communication device, where the first request includes a first identifier, and the first identifier includes at least one of the following: a communication capability identifier; and a sensing capability identifier;
the communication capability identifier is used to indicate to report communication capability information, and the sensing capability identifier is used to indicate to report sensing capability information.

Optionally, in a case that the first identifier includes a sensing capability identifier, the first request further includes a second identifier, where the second identifier is used to indicate to report sensing capability information associated with at least one of the following objects: a sensing action; a service type of integrated sensing and communication; a RAT of integrated sensing and communication; and a band of integrated sensing and communication.

Optionally, the sensing action includes at least one of the following:
transmitting a sensing signal;
receiving a sensing signal;
transmitting or receiving a sensing signal;
transmitting and receiving sensing signals at the same time; and
processing a sensing signal.

Optionally, the radio frequency unit 801 is further configured to:
send a target container to the second communication device, where
the target container carries a second information element, the second information element is used to indicate device capability information, associated with the second identifier, of the first communication device, and the target container corresponds to at least one of the first identifier and the second identifier.

Optionally, in a case that a second request sent by the second communication device is received, if an object indicated by a second identifier in the second request and the object indicated by the second identifier in the first request satisfy a fallback relationship, the first communication device does not need to send, to the second communication device, device capability information associated with the second identifier in the second request.

Optionally, the object indicated by the second identifier in the second request and the object indicated by the second identifier in the first request satisfying a fallback relationship includes at least one of the following:
a band of integrated sensing and communication indicated by the second identifier in the second request is a subset of a band of integrated sensing and communication indicated by the second identifier in the first request;
a RAT of integrated sensing and communication indicated by the second identifier in the second request is a subset of a RAT of integrated sensing and communication indicated by the second identifier in the first request;
a sensing action indicated by the second identifier in the second request is a subset of a sensing action indicated by the second identifier in the first request;
the sensing action indicated by the second identifier in the first request is transmitting and receiving sensing signals at the same time, and the sensing action indicated by the second identifier in the second request is at least one of transmitting a sensing signal, receiving a sensing signal, and transmitting or receiving a sensing signal; and
the sensing action indicated by the second identifier in the first request is transmitting or receiving a sensing signal, and the sensing action indicated by the second identifier in the second request is at least one of transmitting a sensing signal and receiving a sensing signal.

In a case that the terminal is a second communication device,
the radio frequency unit 801 is configured to receive device capability information of a first communication device that is sent by the first communication device, where
the device capability information of the first communication device includes at least one piece of the following sensing capability information:
indication information used to indicate whether sensing is supported;
sensing mobility management capability information;
sensing reporting capability information;
sensing information processing capability information;
sensing signal support capability information;
sensing link adaptation capability information; and
sensing assistance support capability information.

Optionally, the radio frequency unit 801 is further configured to send a first request to the first communication device, where the first request includes a first identifier, and the first identifier includes at least one of the following: a communication capability identifier; and a sensing capability identifier;
the communication capability identifier is used to indicate to report communication capability information, and the sensing capability identifier is used to indicate to report sensing capability information.

Optionally, in a case that the first identifier includes a sensing capability identifier, the first request further includes a second identifier, where the second identifier is used to indicate to report sensing capability information associated with at least one of the following objects: a sensing action; a service type of integrated sensing and communication; a RAT of integrated sensing and communication; and a band of integrated sensing and communication.

Optionally, the radio frequency unit 801 is configured to receive a target container sent by the first communication device, where the target container carries a second information element, the second information element is used to indicate device capability information, associated with the second identifier, of the first communication device, and the target container corresponds to at least one of the first identifier and the second identifier.

Optionally, the second communication device does not send a third request to the first communication device, where the third request includes a second identifier, and an object indicated by the second identifier in the third request and the object indicated by the second identifier in the first request satisfy a fallback relationship.

Optionally, the object indicated by the second identifier in the third request and the object indicated by the second identifier in the first request satisfying a fallback relationship includes at least one of the following:
a band of integrated sensing and communication indicated by the second identifier in the third request is a subset of a band of integrated sensing and communication indicated by the second identifier in the first request;
a RAT of integrated sensing and communication indicated by the second identifier in the third request is a subset of a RAT of integrated sensing and communication indicated by the second identifier in the first request;
a sensing action indicated by the second identifier in the third request is a subset of a sensing action indicated by the second identifier in the first request;
the sensing action indicated by the second identifier in the first request is transmitting and receiving sensing signals at the same time, and the sensing action indicated by the second identifier in the third request is at least one of transmitting a sensing signal, receiving a sensing signal, and transmitting or receiving a sensing signal; and
the sensing action indicated by the second identifier in the first request is transmitting or receiving a sensing signal, and the sensing action indicated by the second identifier in the third request is at least one of transmitting a sensing signal and receiving a sensing signal.

Optionally, the radio frequency unit 801 is further configured to: receive a fourth request sent by a third communication device, where the fourth request is used to request the second communication device to send the device capability information of the first communication device; and
send, to the third communication device, the device capability information of the first communication device corresponding to the fourth request.

Optionally, the fourth request carries at least one of the following:
a device identifier of the first communication device;
a first identifier, where the first identifier includes at least one of the following: a communication capability identifier; and a sensing capability identifier, where the communication capability identifier is used to indicate to report communication capability information, and the sensing capability identifier is used to indicate to report sensing capability information; and
a second identifier, where the second identifier is used to indicate to report sensing capability information associated with at least one of the following objects: a sensing action; a service type of integrated sensing and communication; a RAT of integrated sensing and communication; and a band of integrated sensing and communication.

Optionally, the sensing action includes at least one of the following:
transmitting a sensing signal;
receiving a sensing signal;
transmitting or receiving a sensing signal;
transmitting and receiving sensing signals at the same time; and
processing a sensing signal.

In a case that the terminal is a third communication device,
the radio frequency unit 801 is configured to receive device capability information of a first communication device that is sent by a second communication device, where
the device capability information of the first communication device includes at least one piece of the following sensing capability information:
indication information used to indicate whether sensing is supported;
sensing mobility management capability information;
sensing reporting capability information;
sensing information processing capability information;
sensing signal support capability information;
sensing link adaptation capability information; and
sensing assistance support capability information.

Optionally, the radio frequency unit 801 is further configured to send a fourth request to the second communication device, where the fourth request is used to request the second communication device to send the device capability information of the first communication device.

Optionally, the fourth request carries at least one of the following:
a device identifier of the first communication device;
a first identifier, where the first identifier includes at least one of the following: a communication capability identifier; and a sensing capability identifier, where the communication capability identifier is used to indicate to report communication capability information, and the sensing capability identifier is used to indicate to report sensing capability information; and
a second identifier, where the second identifier is used to indicate to report sensing capability information associated with at least one of the following objects: a sensing action; a service type of integrated sensing and communication; a RAT of integrated sensing and communication; and a band of integrated sensing and communication.

It may be understood that for implementation processes of the implementations mentioned in the embodiments, reference may be made to related descriptions in the method embodiments in FIG. 6, FIG. 7, and FIG. 8, and same or corresponding technical effects are achieved. To avoid repetition, details are not described herein again.

Specifically, the terminal in the embodiments of this application further includes instructions or a program stored in the memory 809 and capable of running on the processor 810. The processor 810 invokes the instructions or the program in the memory 809 to perform the method performed by the modules shown in FIG. 11, FIG. 12, or FIG. 13, and same technical effects are achieved. To avoid repetition, details are not described herein again.

An embodiment of this application further provides a network side device, including a processor and a communication interface. The communication interface is coupled to the processor. The processor is configured to run a program or instructions to implement the steps in the method embodiments shown in FIG. 6, FIG. 7, and FIG. 8. This network side device embodiment corresponds to the foregoing method embodiments. Each implementing process and implementation of the foregoing method embodiments are applicable to the network side device embodiment, and same technical effects can be achieved.

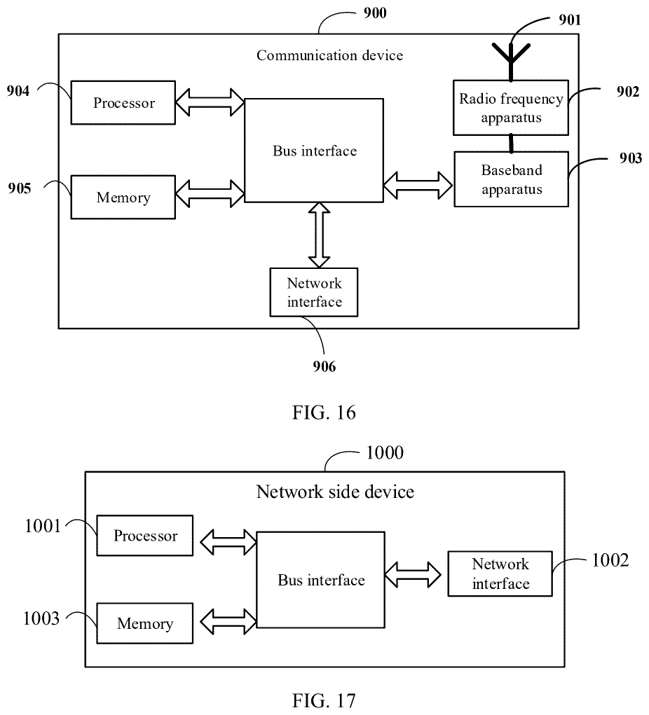

Specifically, an embodiment of this application further provides a network side device. The network side device may be a first communication device, a second communication device, or a third communication device. As shown in FIG. 16, the network side device 900 includes an antenna 901, a radio frequency apparatus 902, a baseband apparatus 903, a processor 904, and a memory 905. The antenna 901 is connected to the radio frequency apparatus 902. In an uplink direction, the radio frequency apparatus 902 receives information through the antenna 901, and sends the received information to the baseband apparatus 903 for processing. In a downlink direction, the baseband apparatus 903 processes to-be-sent information, and sends processed information to the radio frequency apparatus 902. After processing the received information, the radio frequency apparatus 902 sends processed information through the antenna 901.

The method performed by the network side device in the foregoing embodiment may be implemented in the baseband apparatus 903. The baseband apparatus 903 includes a baseband processor.

For example, the baseband apparatus 903 may include at least one baseband board. A plurality of chips are disposed on the baseband board. As shown in FIG. 16, one of the chips is, for example, the baseband processor, and is connected to the memory 905 by using a bus interface, to invoke a program in the memory 905 to perform an operation of a network device shown in the foregoing method embodiment.

The network side device may further include a network interface 906, and the interface is, for example, a common public radio interface (CPRI).

Specifically, the network side device 900 in this embodiment of the present invention further includes instructions or a program stored in the memory 905 and capable of running on the processor 904. The processor 904 invokes the instructions or the program in the memory 905 to perform the method performed by the modules shown in FIG. 11, FIG. 12, or FIG. 13, and same technical effects are achieved. To avoid repetition, details are not described herein again.

Specifically, an embodiment of this application further provides a network side device. As shown in FIG. 17, the network side device 1000 includes a processor 1001, a network interface 1002, and a memory 1003. The network interface 1002 is, for example, a common public radio interface (CPRI).

Specifically, the network side device 1000 in this embodiment of the present invention further includes instructions or a program stored in the memory 1003 and capable of running on the processor 1001. The processor 1001 invokes the instructions or the program in the memory 1003 to perform the method performed by the modules shown in FIG. 11, FIG. 12, or FIG. 13, and same technical effects are achieved. To avoid repetition, details are not described herein again.

An embodiment of this application further provides a readable storage medium. The readable storage medium stores a program or instructions. The program or the instructions are executed by a processor to implement the processes in the foregoing embodiments of the information sensing method, or the program or the instructions are executed by a processor to implement the processes in the foregoing embodiments of the information receiving method, and same technical effects can be achieved. To avoid repetition, details are not described herein again.

The processor is a processor in the terminal described in the foregoing embodiments. The readable storage medium includes a computer-readable storage medium, for example, a computer read-only memory ROM, a random access memory RAM, a magnetic disk, or an optical disc. In some examples, the readable storage medium may be a non-transient readable storage medium.

An embodiment of this application further provides a chip. The chip includes a processor and a communication interface. The communication interface is coupled to the processor. The processor is configured to run a program or instructions to implement the processes in the foregoing embodiments of the information sending method, or to implement the processes in the foregoing embodiments of the information receiving method, and same technical effects can be achieved. To avoid repetition, details are not described herein again.

It should be understood that the chip mentioned in this embodiment of this application can also be referred to as a system-level chip, a system chip, a chip system, a system on chip, or the like.

An embodiment of this application further provides a computer program/program product. The computer program/program product is stored in a storage medium. The computer program/program product is executed by at least one processor to implement the processes in the foregoing embodiments of the information sending method or the information receiving method, and same technical effects can be achieved. To avoid repetition, details are not described herein again.

An embodiment of this application further provides an information transceiving system, including a first communication device, a second communication device, and a third communication device, where the first communication device may be configured to perform the steps of the foregoing information sending method, the second communication device may be configured to perform the steps of the foregoing information receiving method applied to the second communication device, and the third communication device may be configured to perform the steps of the foregoing information receiving method applied to the third communication device.

It should be noted that in this specification, the term “comprise”, “include”, or any of their variants is intended to cover a non-exclusive inclusion, so that a process, a method, an article, or an apparatus that includes a list of elements not only includes those elements but also includes other elements that are not expressly listed, or further includes elements inherent to such process, method, article, or apparatus. Without more constraints, an element preceded by “includes a . . . ” does not preclude the existence of additional identical elements in the process, method, article, or apparatus that includes the element. In addition, it should be noted that the scope of the method and apparatus in the implementations of this application is not limited to performing functions in a sequence shown or discussed, and may further include performing functions in a basically simultaneous manner or in a reverse sequence based on related functions. For example, the described method may be performed in an order different from the described order, and various steps may be added, omitted, or combined. In addition, features described with reference to some examples may be combined in other examples.

According to the foregoing descriptions of the implementations, a person skilled in the art may clearly understand that the method in the foregoing embodiments may be implemented by a computer software product and a necessary general-purpose hardware platform, or certainly may be implemented by hardware. The computer software product is stored in a storage medium (such as a ROM, a RAM, a magnetic disk, or an optical disc) and includes several instructions for instructing a terminal or a network side device to perform the methods described in the embodiments of this application.

The foregoing describes the embodiments of this application with reference to the accompanying drawings. However, this application is not limited to the foregoing specific implementations. The foregoing specific implementations are merely illustrative rather than restrictive. Inspired by this application, a person of ordinary skill in the art may develop many forms of implementations without departing from principles of this application and the protection scope of the claims, and all such implementations fall within the protection scope of this application.

1. An information sensing method, comprising:
sending, by a first communication device, device capability information of the first communication device to a second communication device, wherein
the device capability information of the first communication device comprises at least one piece of the following sensing capability information:
indication information used to indicate whether sensing is supported;
sensing mobility management capability information;
sensing reporting capability information;
sensing information processing capability information;
sensing signal support capability information;
sensing link adaptation capability information; or
sensing assistance support capability information.

2. The method according to claim 1, wherein the device capability information of the first communication device is carried in a first information element, and the first information element is used to indicate at least one of communication capability information or sensing capability information.

3. The method according to claim 1, wherein the sensing mobility management capability information is used to indicate at least one of the following:
whether sensing mobility management is supported;
a measurement quantity supported by the sensing mobility management;
a measurement object supported by the sensing mobility management; or
a measurement event supported by the sensing mobility management.

4. The method according to claim 1, wherein the sensing reporting capability information is used to indicate one of the following:
whether a physical uplink control channel PUCCH reporting a sensing measurement quantity is supported;
whether the PUCCH reporting a sensing result is supported;
whether a physical uplink shared channel PUSCH reporting a sensing measurement quantity is supported;
whether the PUSCH reporting a sensing result is supported; or
a supported reporting manner of the sensing measurement quantity or the sensing result, wherein the reporting manner comprises at least one of periodic reporting, semi-persistent reporting, and or aperiodic reporting.

5. The method according to claim 1 wherein the sensing information processing capability information is used to indicate at least one of the following:
a supported sensing signal processing type;
a sensing data processing capability;
whether conversion from the sensing measurement quantity to the sensing result is supported;
a coherent processing time supported by performing sensing signal processing;
a data computing capability of a sensing service;
a data storage capability of the sensing service;
whether a sensing requirement processing capability is available; or
whether a sensing result fusion capability is available.

6. The method according to claim 5, wherein the supported sensing signal processing type comprises a supported sensing signal processing algorithm, and the supported sensing signal processing algorithm comprises at least one of the following: Fourier transform; a spectral analysis operation of a non-uniform sequence; a high resolution algorithm; a constant false alarm detection algorithm; and or an artificial intelligence AI pattern recognition algorithm; or
the sensing data processing capability comprises at least one of the following: whether motion compensation is supported; whether a sensing object trajectory management capability is available; or a supported multi-target sensing capability.

7. The method according to claim 1, wherein the sensing signal support capability information is used to indicate at least one of the following:
a sensing signal transceiving capability;
a sensing beam support capability;
a multi-node collaboration sensing capability;
a multiple input multiple output MIMO sensing capability; or
a multi-radio access technology multi-RAT sensing capability.

8. The method according to claim 7, wherein the sensing signal transceiving capability comprises at least one of the following:
whether receiving a sensing signal is supported; whether transmitting a sensing signal is supported; whether receiving and transmitting a sensing signal is supported; or whether receiving and transmitting sensing signals at the same time are supported; or
the sensing beam support capability comprises at least one of the following: a supported beam saltus; or a supported beam quantity; or
the multi-node collaboration sensing capability comprises at least one of the following: a maximum quantity of ports for transmitting a sensing signal; and or a maximum quantity of ports for receiving a sensing signal; or
the MIMO sensing capability comprises at least one of the following: whether MIMO sensing is supported; a supported maximum quantity of related antenna ports; a supported antenna arrangement; whether switching between MIMO sensing and non-MIMO sensing is supported; or a supported MIMO sensing manner; or
the multi-RAT sensing capability comprises at least one of the following: a radio access technology RAT type that supports a sensing service; or whether multi-RAT collaboration sensing is supported.

9. The method according to claim 1, wherein the sensing assistance support capability information is used to indicate at least one of the following:
whether obtaining device state information is supported;
whether execution of a sensing service is allowed; or
a capability of an equipped sensor.

10. The method according to claim 1, wherein before the sending, by a first communication device, device capability information of the first communication device to a second communication device, the method further comprises:
receiving, by the first communication device, a first request sent by the second communication device, wherein the first request comprises a first identifier, and the first identifier comprises at least one of the following: a communication capability identifier; or a sensing capability identifier;
wherein the communication capability identifier is used to indicate to report communication capability information, and the sensing capability identifier is used to indicate to report sensing capability information.

11. The method according to claim 10, wherein the first identifier comprises the sensing capability identifier, the first request further comprises a second identifier, wherein the second identifier is used to indicate to report sensing capability information associated with at least one of the following objects: a sensing action; a service type of integrated sensing and communication; a RAT of integrated sensing and communication; or a band of integrated sensing and communication.

12. The method according to claim 11, wherein the sensing action comprises at least one of the following:
transmitting a sensing signal;
receiving a sensing signal;
transmitting or receiving a sensing signal;
transmitting and receiving sensing signals at the same time; or
processing a sensing signal.

13. The method according to claim 11, wherein the sending, by a first communication device, device capability information of the first communication device to a second communication device comprises:
sending, by the first communication device, a target container to the second communication device, wherein the target container carries a second information element, the second information element is used to indicate device capability information, associated with the second identifier, of the first communication device, and the target container corresponds to at least one of the first identifier or the second identifier.

14. The method according to claim 11, wherein in response to a second request sent by the second communication device being received, if an object indicated by a second identifier in the second request and the object indicated by the second identifier in the first request satisfy a fallback relationship, the first communication device does not need to send, to the second communication device, device capability information associated with the second identifier in the second request.

15. The method according to claim 14, wherein the object indicated by the second identifier in the second request and the object indicated by the second identifier in the first request satisfying a fallback relationship comprises at least one of the following:
a band of integrated sensing and communication indicated by the second identifier in the second request is a subset of a band of integrated sensing and communication indicated by the second identifier in the first request;
a RAT of integrated sensing and communication indicated by the second identifier in the second request is a subset of a RAT of integrated sensing and communication indicated by the second identifier in the first request;
a sensing action indicated by the second identifier in the second request is a subset of a sensing action indicated by the second identifier in the first request;
the sensing action indicated by the second identifier in the first request is transmitting and receiving sensing signals at the same time, and the sensing action indicated by the second identifier in the second request is at least one of transmitting a sensing signal, receiving a sensing signal, or transmitting or receiving a sensing signal; or
the sensing action indicated by the second identifier in the first request is transmitting or receiving a sensing signal, and the sensing action indicated by the second identifier in the second request is at least one of transmitting a sensing signal or receiving a sensing signal.

16. An information receiving method, comprising:
receiving, by a second communication device, device capability information of a first communication device that is sent by the first communication device, wherein
the device capability information of the first communication device comprises at least one piece of the following sensing capability information:
indication information used to indicate whether sensing is supported;
sensing mobility management capability information;
sensing reporting capability information;
sensing information processing capability information;
sensing signal support capability information;
sensing link adaptation capability information; or
sensing assistance support capability information.

17-23. (canceled)

24. An information receiving method, comprising:
receiving, by a third communication device, device capability information of a first communication device that is sent by a second communication device, wherein
the device capability information of the first communication device comprises at least one piece of the following sensing capability information:
indication information used to indicate whether sensing is supported;
sensing mobility management capability information;
sensing reporting capability information;
sensing information processing capability information;
sensing signal support capability information;
sensing link adaptation capability information; or
sensing assistance support capability information.

25-28. (canceled)

29. A communication device, comprising a processor and a memory, wherein the memory stores a program or instructions capable of running on the processor, and the program or the instructions are executed by the processor to implement the steps of the information sending method according to claim 1.

30. (canceled)

31. A communication device, comprising at least one hardware processor and a memory, wherein the memory stores a program or instructions capable of running on the at least one hardware processor, and the program or the instructions are executable by the at least one hardware processor to implement the information receiving method according to claim 16.

32. A communication device, comprising at least one hardware processor and a memory, wherein the memory stores a program or instructions capable of running on the at least one hardware processor, and the program or the instructions are executable by the at least one hardware processor to implement the information receiving method according to claim 24.
